(19) United States
(12) Patent Application Publication
(10) Pub. No.: US 2004/0239494 A1
(43) Pub. Date: Dec. 2, 2004

(54) Systems and methods for automatic energy analysis of buildings

(76) Inventors: John F. Kennedy, Santa Rosa, CA (US); Patrick J. Bailey, Santa Rosa, CA (US); Thomas P. Conlon, Sonoma, CA (US); Matthew P. Gangemi, Seattle, WA (US); Shin-ta Huang, Taipei (TW); Eliot D. Hance, Penngrove, CA (US)

Correspondence Address: Martin C. Fliesler, FLIESLER DUBB MEYER & LOVEJOY LLP, Fourth Floor, Four Embarcadero Center, San Francisco, CA, 94111-4156, US

(21) Appl. No.: 10/659,932

(22) Filed: Sep. 11, 2003

Related U.S. Application Data
(60) Provisional application No. 60/470,797, filed on May 14, 2003.

(51) Int. Cl. G08B 23/00

(52) U.S. Cl. 340/500

(57) ABSTRACT

Systems and methods of analyzing the energy requirements of a building using a computer network, comprising, under control of a first process, providing a first representation of the building, wherein the first representation of the building is a comprehensive and accurate geometric representation of the building, providing the first representation to a second process on the computer network, under control of the second process, performing an energy analysis of the building based on the first representation, and providing results of the energy analysis wherein the results are available on the computer network, and wherein the first process and the second process can communicate using the computer network.

### CLAIM OF PRIORITY

This application claims priority from the following application, which is hereby incorporated by reference in its entirety:

SYSTEM AND METHOD FOR AUTOMATIC ENERGY ANALYSIS OF BUILDINGS, U.S. Application No. 60/470,708, Inventors: John F. Kennedy, et al., filed on May 14, 2003. (Attorney's Docket No. GEOP-1000US0)

### NOTICE

This invention was made with State of California support under California Energy Commission Contract number 500-98-023. The Energy Commission has certain rights to this invention.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present disclosure relates generally to automatic energy analysis of buildings.

### BACKGROUND

Energy simulations for modeling building heating, cooling, lighting, ventilating, and other energy flows are becoming increasingly important. Energy prices, particularly electricity rates, are on the rise. In addition, state governments are beginning to mandate that new buildings conform to energy efficiency standards. Thus, from economic and regulatory standpoints, it makes sense to design new buildings to maximize energy efficiency. Two widely used software programs for performing energy simulations are DOE-2 and EnergyPlus™. The development of both programs was sponsored by the United States Department of Energy. Despite their apparent usefulness for determining the energy efficiency of building designs, these complex software programs impose significant learning curves. An additional hindrance to using them is that they require a voluminous amount of weather, building and equipment-related input data in addition to a building's basic geometry. As a result, architects may be inclined to put off performing an energy simulation until a building design is near completion. At such a late stage, however, it may be impractical to implement any design changes that could significantly impact energy efficiency.

### BRIEF DESCRIPTION OF THE DRAWINGS

FIG. 1 is a high-level illustration of a system for performing automated energy analysis of one or more buildings in an embodiment of the invention.

FIG. 2 illustrates a logical organization of building information in one embodiment of the invention.

FIG. 3 is a flow diagram of a routine for converting a 3D volumetric building model into a 3D mono-planar model in an embodiment.

FIG. 4 is an illustration of walls and surfaces in a 3D design.

FIG. 5 is a flow diagram of a routine for automatically determining model defaults in an embodiment.

FIG. 6 is a flow diagram of a routine for optimizing a building model.

FIG. 7 is an illustration of a graphical user interface in an embodiment.

FIG. 8 is an illustration of a graphical user interface for providing the results of a simulation run in an embodiment.

FIG. 9 is an illustration of a graphical user interface for presenting recommendations in an embodiment.

FIG. 10 is an illustration of a graphical user interface for presenting information access options in an embodiment.

FIG. 11 is a flow diagram of a routine for qualifying advertisements in an embodiment.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

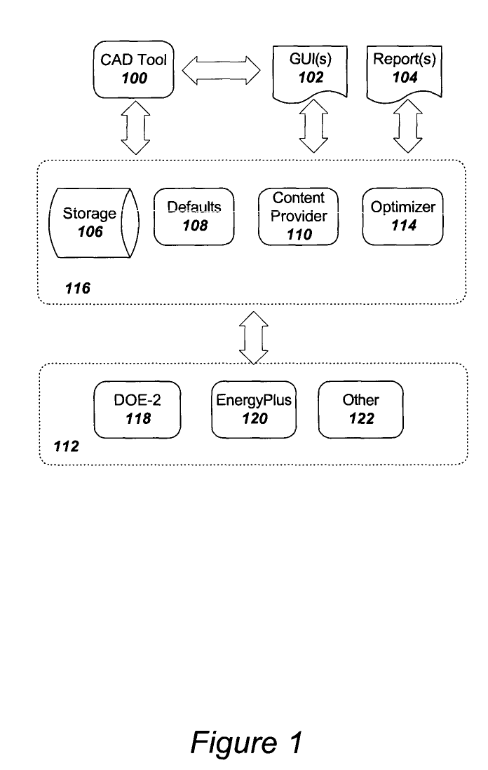

FIG. 1 is a high-level illustration of a system for performing automated energy analysis of one or more buildings in an embodiment of the invention. Although this diagram depicts objects/processes as logically separate, such depiction is merely for illustrative purposes. It will be apparent to those skilled in the art that the objects/processes portrayed in this figure can be arbitrarily combined or divided into separate software, firmware or hardware components. Furthermore, it will also be apparent to those skilled in the art that such objects/processes, regardless of how they are combined or divided, can execute on the same computing device or can be distributed among different computing devices connected by one or more networks.

Referring to FIG. 1, a three-dimensional (3D) computer aided design (CAD) tool or Building Information Model Application (BIMA) 100 can be used to design one or more buildings/structures. Although this disclosure is not limited to or dependent on any particular 3D CAD/BIMA tool, one embodiment can utilize Artifice DesignWorkshop® by Artifice, Inc. of Eugene, Oreg. Another suitable 3D CAD package is Architectural Desktop by Autodesk, Inc. of San Rafael, Calif. The 3D CAD tool has an internal CAD representation of the building(s) being designed. Although the internal representation may be specific to a given tool, it generally can include information describing the detailed geometry of the one or more buildings, the materials to be used in construction, internal and external equipment, HVAC (heating, ventilation, air conditioning), finishes, landscaping, etc. However, only a small subset of this information is necessary in order to perform an automatic energy analysis in accordance to one embodiment. This feature allows architects to freely explore the energy efficiency of buildings at an early stage in the design process without the encumbrance of having to specify all of the design details an energy simulation program may require.

In one embodiment, the CAD representation it is converted into a model by a transformation. Details of an exemplary transformation will be provided below. In one embodiment, the CAD representation and model are the same and thus no transformation is required. The model can include some or all of the information in the CAD representation. In one embodiment, the model includes a complete, accurate and true geometric representation of the building, its spaces, surfaces and openings. Although this disclosure is not limited to or dependent on any particular model, in one embodiment the model can be an XML (extensible Markup Language) document. XML is an industry-wide standard document markup language. XML documents can be defined by a schema which is a set of rules and/or structure that formally defines the format of an XML document. In another embodiment, the model can be a gbXML (Green Building XML) document which is defined by the gbXML XML schema. The gbXML schema is available from http://www.gbxml.org and is a public domain standard developed to facilitate the transfer of building information stored in CAD models. In another embodiment, the model can include Industry Foundation Classes, the definition of which is available from the International Alliance for Interoperability of North America. In yet another embodiment, the model can be compressed, encrypted and/or encoded.

The model can be provided to EAM (Energy Analysis Module) 116. In one embodiment, this activity can be initiated by a user through one or more interactions with a graphical user interfaces (GUIs) 102 (e.g., a web page, application program, or other suitable interface) and/or reports 104. In one embodiment, user interaction can be accomplished with an input device (not shown) that is coupled at least one of the GUIs. By way of a non-limiting example, the interaction can include clicking on a mouse button, typing a key on a keyboard, touching or tapping a digitizer, making contact with a touch-sensitive device, making a sound, sending a command through a remote control device or other computing device, depressing a button, performing a hand or facial gesture, sending a command from a personal digital assistant, etc. In another embodiment, the model can be provided to the EAM without requiring any user interaction to initiate the process. By way of a non-limiting example, this might be accomplished by the CAD tool itself, or by some other process/thread of execution, operating on the same computing device as the CAD tool or on a different computing device.

In one embodiment, the EAM can be partially or wholly incorporated into the CAD tool. In another embodiment, the EAM can be implemented as a server or as a web service. Although the EAM is not tied to any particular implementation, one possible implementation is as an ActiveX DLL (dynamic link library). Programming tools and libraries that support ActiveX are available from Microsoft Corp. of Redmond, Wash. In another embodiment, the EAM can be implemented as a Java™ Bean or as a Java Servlet. The Java programming language and run-time environment are available from Sun Microsystems, Inc. of Santa Clara, Calif.

In one embodiment, the model can be provided to the EAM via any number of network protocols including but not limited to: SOAP (Simple Object Access Protocol), HTTP (Hypertext Transfer Protocol), HTTP/S (Hypertext Transfer Protocol/Secure), TCP/IP (Transmission Control Protocol/Internet Protocol), UDP (User Datagram Protocol), etc. In another embodiment, the model can be provided via shared memory or via a file system. In yet another embodiment, the model can be provided to the EAM via an instantiated class object. Regardless of how the model is provided to the EAM, it may also be provided in a compressed, encrypted and/or encoded form.

A defaults component 108 can automatically populate the model with intelligent defaults. Defaults can be stored in storage component 106 (e.g., random access memories, file system(s), relational database(s), shared memory, read-only memory, and other suitable storage mechanisms.). Although the storage component is illustrated as single component, it may be divided into separate storage components that can be distributed on one or more computer networks. Many of the defaults are based on the geographic location of the building(s) as indicated by the model, the sizes of the buildings, and applicable energy codes. (The process of selecting default values is discussed below.) Defaults can include: 1) HVAC equipment; 2) weather-related information; 3) interior/exterior constructions; 4) interior/exterior lighting equipment; 5) schedules of operations for interior/exterior lights; 6) interior/exterior equipment; 7) schedules of operations for interior/exterior equipment; 8) air flow information; 9) schedules of operations for heating, ventilation and/or air conditioning equipment; 10) number of people; 11) schedules of occupancy for people; and 12) any additional information necessary to conduct a building energy analysis.

A model populated with defaults can optionally be stored or cached in the storage component for future use. The information in the populated model can be transformed into a simulation parameters format which is suitable for providing to the analyzer component 112. In one embodiment, the transformation can be accomplished using a Web Style Sheet. A web style sheet describes how a document can be automatically converted from one format to another. Information on style sheets is available from http://www.w3.org. In one embodiment, the populated model and the simulation parameters are the same, and thus no transformation is necessary.

In one embodiment, the analyzer component performs an energy analysis based on the simulation parameters. The analyzer component may be one or more stand-alone processes and/or may be integrated partially or wholly into the EAM. Although this disclosure is not dependent on or limited to any particular software, one suitable analyzer component is the IDEA Server®, available from GeoPraxis, Inc. of Petaluma, Calif. In one embodiment, the analyzer component can communicate with the EAM through a number of means including (but not limited to) network protocols, file systems, distributed objects, memory, shared memory and other suitable means.

In one embodiment, the analyzer component utilizes one or more simulators (118-122) to perform an energy analysis based on the simulation parameters. In one embodiment, a simulator determines the energy use and/or cost of a building on an hourly or other basis using information that can include the building's geographical location (i.e., climate), its three-dimensional geometry, construction materials, utility rate schedule, and HVAC equipment. One suitable simulator is DOE-2 118, named for the government agency that sponsored its development (U.S. Department of Energy). DOE-2 is commercially available Lawrence Berkeley National Laboratory (Berkeley, Calif.) and James Hirsch & Associates. EnergyPlus™ 120 is another suitable simulator. Its development was also sponsored in part by the U.S. Department of Energy and it is available from the Lawrence Berkeley National Laboratory. The analyzer component can provide a plug-able software architecture via an application program interface (API), service provider interface (SPI), or other mechanism, to accommodate new simulators 122 as they become available.

The analyzer component provides simulation results to the EAM. The simulation results can be transformed back into the original model format. In one embodiment, the results of the simulation are incorporated into the populated model as part of this transformation. The EAM can optionally store the results for future reference in the storage component. The resulting model can be provided to the CAD tool. The CAD tool can optionally transform the results into its internal CAD representation, thereby automatically integrating the EAM's model defaults and results. (If the internal representation and the model are compatible, no transformation may be necessary.) In one embodiment, the model can be provided to the CAD tool via any number of network protocols including but not limited to: SOAP, HTTP, HTTP/S, TCP/IP, UDP, or other suitable protocols. In another embodiment, the model can be provided via shared memory or via a file system. In yet another embodiment, the model can be provided to the CAD tool via an instantiated class object. Regardless of how the model is provided to the tool, it may also be provided in a compressed, encrypted and/or encoded form.

In one embodiment, the model and/or simulation results can be manipulated by an optimizer component 114. The optimizer can automatically operate on the model and cause additional simulations to be performed in order to provide a ranking of alternative designs based on factors including but not limited to energy efficiency, cost savings, project cost, and/or other suitable factors. In one embodiment, the optimizer can optimize at least one of the following parameters: 1) building orientation; 2) glazing; 3) construction materials; 4) heating air conditioning and/or ventilation systems; 5) lighting and light control schemes; and 6) any information in the first representation. Optimization is further discussed below.

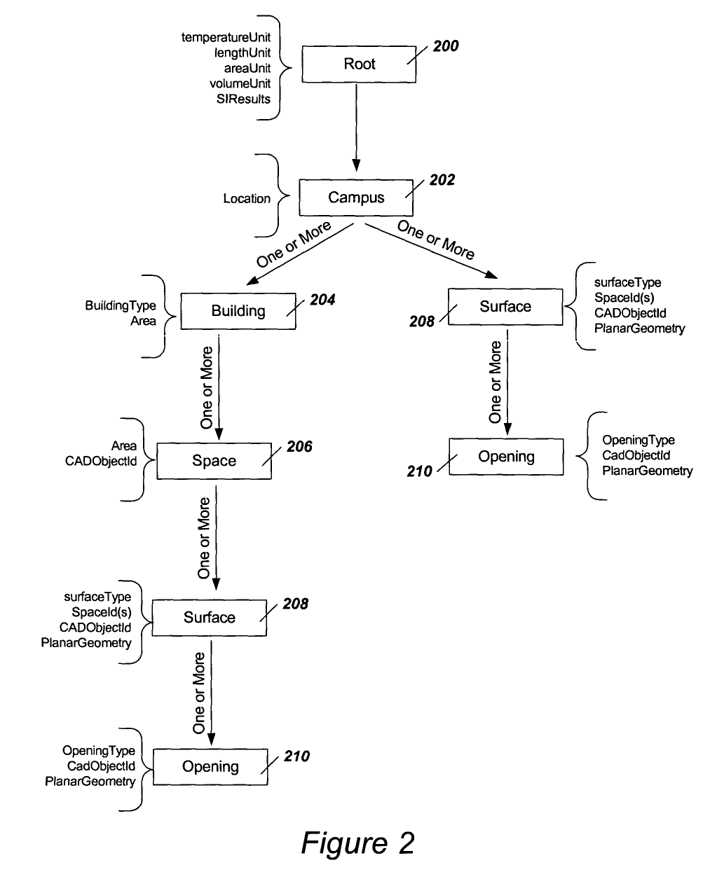

FIG. 2 illustrates a logical organization of building information in one embodiment. The EAM expects a minimal amount of building information in the model 104. In one embodiment, this information can include (generally speaking) the 3D geometry of the building(s), the geographic location of the building(s) as indicated by a postal zip code or other indicia of location, the type of building, and (optionally) one or more spaces defined within the building(s). By way of a non-limiting example, this minimal information can be organized in a logical hierarchy of nodes wherein each node can optionally have attributes and/or children nodes. Attributes are properties/values associated with a node. A node's children are the hierarchical descendents of the node. In one embodiment, some nodes may have an identifier attribute that serves to uniquely identify the node. In another embodiment, nodes and their associated attributes are represented as elements and/or attributes in a gbXML document.

Root node 200 has several attributes which serve as global simulation settings. These include temperatureUnit, lengthUnit, areaUnit, and volumeUnit. These specify units to be used for temperature, length, area and volume, respectively. In addition, the root node has an SIResults attribute which is a Boolean value used to identify the units that the energy simulation results should be in (i.e., International System of Units (SI) or Imperial Units (IP)). Optional root node attributes (not shown) include: CompanyName (e.g., the CAD tool developer's name), ProductName (e.g., the product name of the CAD tool), Version (e.g., the version of the CAD tool), Platform (e.g., the computer platform that the CAD tool is running on), and CreatorPersonInfo (e.g., information concerning the user).

The root node 200 can have a campus 202 child node. A campus is a collection of related buildings/structures. The campus node includes a location attribute that can specify the name of the campus location, its postal or zip code, longitude, latitude and/or elevation. The location information can be used to obtain meteorological information, energy costs, and other relevant information. In addition, the campus node can optionally include the following attributes (not shown): DesignHeatWeathIdRef, DesignCoolWeathIdRef, YearModeled, MeterId, ExtEquipId, LightId, LightControlId, and ScheduleIdRef. The DesignHeatWeathIdRef attribute specifies the heating design used for load calculations and sizing equipment. The DesignCoolWeathIdRef attribute specifies the cooling design used for load calculations and sizing equipment. The YearModeled specifies the year of the simulation (by default the current year is the year used in all analyses). MeterId specifies the energy meters assigned to the campus. ExtEquipId specifies the external equipment assigned to the campus. LightId specifies the lighting assigned to the campus. The LightControlId attribute specifies the lighting control element for the assigned LightId. The LightId is the identifier for the light element controlled by the lighting control. Finally, the ScheduleIdRef is the identifier for the schedule that defines how a light operates.

A campus 202 can have one or more building nodes 204 as its children. A building node represents a collection of spaces and surfaces. Building nodes include a BuildingType attribute that characterizes the function of the building (e.g., AutomotiveFacility ConventionCenter, Courthouse, Dining-BarLoungeOrLeisure, Dining-Family, Dormitory, ExerciseCenter, FireStation, Hotel, Hospital, etc.) and an Area attribute which provides the total floor area of the building. In one embodiment, the Area is the sum of all floor areas contained in space elements whose height is over five feet or is occupied. In addition, a building node can include the following optional attributes (not shown): unit (specifying the units of the building area), Name (name of the building) and Description (a description of the building).

Building nodes can have one or more space nodes 206 as children. A space node represents a volume enclosed by surfaces (e.g., a room in a building). Space nodes include an Area attribute and a CADObjectID attribute. In one embodiment, the Area is the total floor area of the space as measured by the sum of areas for each Surface element of type InteriorFloor, UndergroundSlab, RaisedFloor, or SlabOnGrade contained in the space. (Surfaces are discussed below.) In one embodiment, the Area can include a unit type specifying the units of the area. The CADObjectID attribute contains the CAD tool's unique identifier for this space. A space can optionally have the following attributes (not shown): Name, Volume, conditionType, and spaceType. The Name attribute can be the name of space. The Volume attribute contains the volume (and optimally its unit) of the space as defined by the volume enclosed by all the surfaces adjacent to this space. The conditionType identifies the type of heating, cooling, or ventilation the space has (e.g., heated, cooled, HeatedAndCooled, Unconditioned, Vented, NaturallyVentedOnly, etc.). Finally, the spaceType identifies the type of space defined (e.g, Airport Concourse, Active Storage, Bank Customer Area, Dining Area, etc.). Allowing the user to specify the spaceType can enable the EAM to better choose defaults that approximate the actual internal loads and schedules associated with the defined space type.

Space nodes 206 and the Campus node 202 can have one or more surface nodes 208 as children. A surface node represents a planar polygon that represents interior and exterior walls, ceilings, floors, slabs, roofs, and other opaque diaphragm type structures in a building. The EAM can use surface nodes to define the surfaces bounding a space or shading a building. In one embodiment, a surface described with a surface node can be adjacent to a maximum of two spaces. A surface node can have a surfaceType (see Table 1) that characterizes the surface by its function. A surface node can also have a SpaceId, CADObjectId, and PlanarGeometry. The SpaceId contains the identifier of the space or spaces (maximum of two) adjacent to this surface. The CADObjectId contains the CAD tool's unique identifier for this surface.

The PlanarGeometry attribute of a surface node describes the surface as a three dimensional polygon that lies on a plane. It includes a list of coordinates that make up the polygon. In one embodiment, the center plane of interior and shading surfaces and the outside plane of exterior surfaces is used. If a surface is curved, it can be faceted, then broken into smaller planar surfaces. In one embodiment, the right-hand rule is used for exterior surfaces in determining the outward normal. In addition, a surface node can include the following optional attributes (not shown): Name, Element, Description, and exposedToSun. Name is the name of the surface and description is a textual description. A Boolean attribute exposedToSun is used by the EAM to determine if surface is exposed to the sun. A value of True indicates that surface does have direct sun irradiation incident upon it at some point during the year whereas a value of False indicates it does not.

TABLE 1
Surface Types in an Embodiment

| | | | TILT RANGE | |
|---|---|---|---|---|
| | | | (OUTWARD | |
| | | | NORMAL | |
| | | NUMBER OF | VECTOR - 0° | MONO- |
| | | ADJACENT | FACES UP, | PLANAR |
| SURFACE TYPE | | SPACES & | 180° FACES | PLANE |
| ENUMERATION | DESCRIPTION | TYPE | DOWN) | LOCATION |
| InteriorWall | Surface on the side of a | Adjacent to two | 45° to 149.99° | Centerline |
| | space with an adjacent | conditioned or | | |
| | space on the other side | unconditioned | | |
| | of it. | spaces. | | |
| ExteriorWall | Surface on the side of a | Adjacent to one | 45° to 149.99° | Outside |
| | space with exterior | conditioned or | | |
| | conditions on the other. | unconditioned | | |
| | | space and the | | |
| | | outdoor | | |
| | | environment. | | |
| Roof | Surface on top of a | Adjacent to one | 0° to 44.99° | Outside |
| | space and exterior | conditioned or | | |
| | conditions on the other. | unconditioned | | |
| | | space and the | | |
| | | outdoor | | |
| | | environment. | | |
| InteriorFloor | Surface on the bottom | Adjacent to two | 150° to 180° | Centerline |
| | of an occupied space | conditioned or | | |
| | with an adjacent space | unconditioned | | |
| | below it. | spaces. | | |
| Shade | Surface that is not in | Not adjacent to | 0° to 180° | Centerline |
| | contact with any space. | any spaces. The | | |
| | | outdoor | | |
| | | environment is | | |
| | | on either side of | | |
| | | the surface. | | |
| UndergroundWall | Below grade surface | Adjacent to one | 45° to 149.99° | Outside |
| | that is on the side of a | conditioned or | | (adjacent to |
| | space with earth contact | unconditioned | | soil) |
| | on the opposite side of | space and earth | | |
| | it. | (soil). | | |
| UndergroundSlab | Below grade surface | Adjacent to one | 150° to 180° | Outside |
| | that is on the bottom of | conditioned or | | (adjacent to |
| | a space with earth | unconditioned | | soil) |
| | contact on the opposite | space and earth | | |
| | side of it. Generally | (soil). | | |
| | made from concrete. | | | |
| Ceiling | Surface that is on top of | Adjacent to two | 0° to 44.99° | Centerline |
| | an occupied space with | conditioned or | | |
| | an unoccupied space | unconditioned | | |
| | above it. | spaces. | | |
| Air | Nonexistent surface | Adjacent to two | 0° to 180° | Centerline |
| | used to “divide” large | conditioned or | | |
| | spaces into smaller | unconditioned | | |
| | spaces separated by a | spaces. | | |
| | air “surface”. | | | |
| UndergroundCeiling | Below grade surface | Adjacent to one | 0° to 44.99° | Outside |
| | that is on the top of a | conditioned or | | (adjacent to |
| | space with earth contact | unconditioned | | soil) |
| | on the opposite side of | space and earth | | |
| | it. | (soil). | | |
| RaisedFloor | Surface on the bottom | Adjacent to one | 150° to 180° | Outside |
| | of a space with exterior | conditioned or | | |
| | conditions on the other | unconditioned | | |
| | side. | space and the | | |
| | | outdoor | | |
| | | environment. | | |
| SlabOnGrade | Surface on the bottom | Adjacent to one | 150° to 180° | Outside |
| | of a space with earth | conditioned or | | (adjacent to |
| | contact on the opposite | unconditioned | | soil) |
| | side of it. Generally | space and earth | | |
| | made from concrete. | (soil). | | |

In one embodiment, vertical and horizontal clipping can be performed on surfaces that are adjacent to more than two spaces. Thereafter, the number of adjacent spaces to a surface dictates if the surface is an interior, exterior, or shading surface. If a surface is adjacent to two spaces then it is an interior surface, and two AdjacentSpaceId elements are used to reference the Identifier for the adjacent spaces. If a surface is adjacent to only one space then it is an exterior surface, and only one AdjacentSpaceId element is used. If a surface is not adjacent to any space then it is a shading surface.

Surface nodes 208 can have zero or more openings 210 which represent a large penetration in a surface where a window, skylight, or a door may fit. An opening can also have nothing in it except air. Openings can have an openingType attribute identifying the type of opening defined (see Table 2), a CADObjectId containing the CAD applications unique identifier for this opening, and a PlanarGeometry. Optionally, an opening can be given a Name.

TABLE 2
Opening Types in an Embodiment

| OPENING TYPE | | ALLOWED |
|---|---|---|
| ENUMERATION | DESCRIPTION | SURFACE TYPES |
| FixedWindow | Opening in a surface that is | InteriorWall, |
| | on the side of a space with | ExteriorWall, |
| | a non-operable window in it. | Underground Wall |
| OperableWindow | Opening in a surface that is | InteriorWall, |
| | on the side of a space with an | ExteriorWall, |
| | operable window in it. | UndergroundWall |
| FixedSkylight | Opening in a surface that is | Roof, |
| | on the top of a space with a | UndergroundCeiling |
| | non-operable window in it. | |
| OperableSkylight | Opening in a surface that is | Roof, |
| | on the top of a space with an | UndergroundCeiling |
| | operable window in it. | |
| Door | Opening in a surface that is | InteriorWall, |
| | on the side of a space with a | ExteriorWall, |
| | sliding door in it. | UndergroundWall, |
| | | Ceiling, |
| | | InteriorFloor, |
| | | RaisedFloor |
| Air | Opening in a surface that | InteriorWall, |
| | has no window or door in it. | ExteriorWall, |
| | | UndergroundWall, |
| | | Roof, |
| | | UndergroundCeiling, |
| | | Ceiling, |
| | | InteriorFloor, |
| | | RaisedFloor |

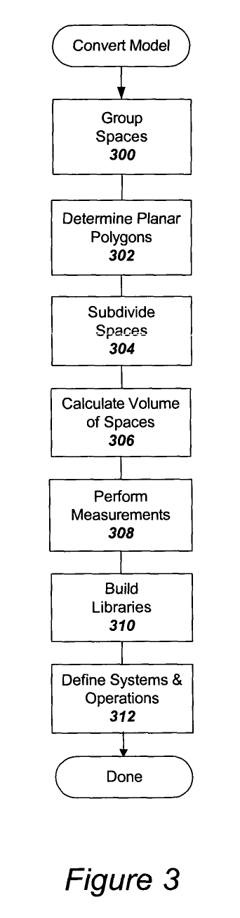

FIG. 3 is a flow diagram of a routine for automatically converting a 3D volumetric building model into a 3D mono-planar model in an embodiment. Although this figure depicts functional steps in a particular order for purposes of illustration, the process is not limited to any particular order or arrangement of steps. One skilled in the art will appreciate that the various steps portrayed in the figure could be omitted or rearranged or adapted in various ways.

A 3D mono-planar model can be better suited to performing energy analysis simulations for reasons related to calculating thermal loads. In one embodiment, this conversion can be performed by a CAD tool prior to transforming the internal representation to the model. In one embodiment, it is assumed that the location of all buildings in a plan can be determined relative to a known origin and that the geographical location of a building is also known.

Steps 300-310 define for each building its envelope and constructions. Step 300 represents the grouping of spaces. This step requires that unconditioned spaces versus conditioned spaces are identified as such. An unconditioned space does not receive any HVAC services. This is done based on analyzing the internal representation for the descriptions of the spaces and/or recognizing that some spaces (e.g., plenum) are unconditioned. Unspecified volumes can be treated as large, unconditioned spaces based on whether the space can be occupied based on its height. If it is too low for people to stand in then it is most likely an unconditioned space. If the height of the volume is less than approximately two feet then it is assumed to be a thick construction and can be modeled as a surface.

Step 300 also identifies space types (e.g., office, hallway, conf. room, etc.) by space descriptions or layouts. Similar small spaces having similar external thermal loads and HVAC schedules can be combined into simulated spaces. In one embodiment, similar external thermal loads are determined by wall constructions and orientation. On a large floor with windows on each side, for example, there are typically zones for each perimeter orientation and a core zone. In one embodiment, perimeter zones are typically about 15 feet deep.

In Step 302, for each space or grouped space, the end-point coordinates of each space's enclosing walls are determined (i.e., where the wall meets the floor). Exterior walls are measured on their exterior plane and interior walls are measured on their centerline plane. Interior walls are extended to an exterior wall's exterior plane for their connecting coordinate.

In Step 304, if there is a large space that has large interior openings separating the space into smaller spaces, these openings can be used as virtual walls (air walls) to cut the larger space into smaller spaces. This is done when a large space has either of the following: 1) exterior walls that have multiple and unique exposures to different Cartesian directions; or 2) clearly defined unique mechanical HVAC needs to separate parts of the space often indicated by multiple thermostats in the large space. The resulting planar polygon defining the space can also define the polygon of the space's floor and ceiling. In one embodiment, multilevel floors can be simplified by making them into a single floor (e.g., a theatre with a stage). If the difference in height is equivalent to a new floor (e.g., a mezzanine), that section of the floor will be divided into two spaces, one over the other.

The floor and the ceiling planar polygon surfaces can be divided depending on what is adjacent to them. For instance, the floor may cantilever over an exterior walkway as well as two spaces below it. The floor polygon is then divided into three floor polygons, one for the cantilever portion, and two for each space the floor is over. The actual area of the space is based on the sum of the area of the above the polygons.

In Step 306, the average height of the ceiling for the space is determined and, along with the space area, is used to calculate the estimated space volume. In one embodiment, the simulation results are not highly sensitive to variations in the volume of spaces; so errors introduced by averaging the height of the ceiling will not be significant.

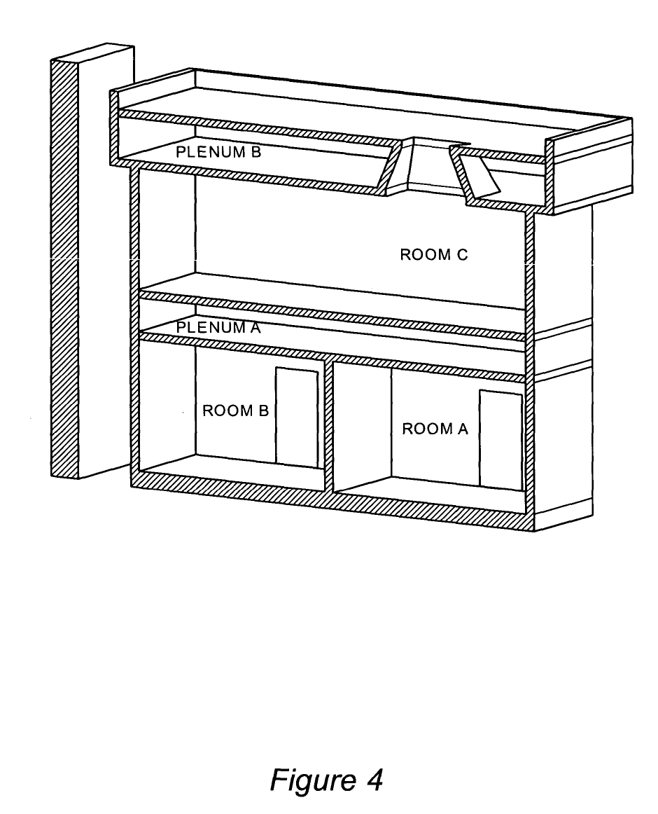

In step 308, the surface width, height, azimuth, and the planar polygon are determined for each wall's surface representation wherein the wall encloses a space. The wall can be subdivided to accommodate unique orientations and constructions. In one embodiment, the steps mentioned above for floors and ceiling for adjacent spaces is also applied. For example, in FIG. 4 on the left Room C has a skylight well with walls adjacent to Plenum B. In one embodiment, these walls will need surfaces defined for them that are in Room C.

Openings for all surfaces enclosing the space including windows, doors, and skylights can be determined. The height and width as well as the polygons for each of these openings is calculated. For exterior walls and windows where there exists any exterior shading surfaces that are attached to the wall or window and are unique to that wall or window, define these surfaces as shading surfaces with their height, width and polygon. Surfaces that shade large portions of the building that are not unique to any one space wall or window can be defined as shading surfaces with their height, width and polygon. If an adjacent structure or vegetation will shade the building a planar surface can be defined that simulates that shading structure a polygon can be defined for the planar structure and give it a name.

In Step 310, determine the thermal and optical properties of all surfaces and build material and construction “libraries” that will be assigned to each wall, floor, ceiling and roof in the building. Do the same with windows, doors, and skylights.

Optional Step 312 defines building systems and operation. The EAM does not expect CAD tools to produce this information. However, if the following information is specified in the model, the EAM can make use of it in one embodiment:

The types, location, and efficacy of the lighting systems for each space. Also, any significant electrical or fuel using equipment's energy use in the space such as computers, copiers, printers, or cooking equipment.

Usage schedules for operational characteristics including lighting, plug loads (receptacles), infiltration, occupancy. HVAC fans (on/off), thermostats, outside ventilation air and numerous others. These schedules can be based on either actual operation or energy code based assumptions.

HVAC systems that are the nearest equivalent to the actual systems existing or contemplated for a building. This includes defining heating fuels, air vs. water systems, efficiencies for the system components, sizing, control parameters (based on temperature, humidity, enthalpy, time of day or season).

Simulated spaces to simulated HVAC zones based on a many to one correspondence. Assign each of these HVAC zones to one HVAC system. If required, assign HVAC systems to an appropriate central plant chiller and/or boiler system. Some system types, for example residential air conditioners, do not have a central plant.

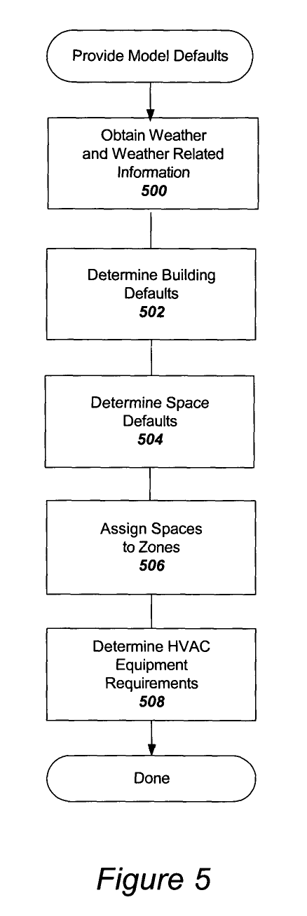

FIG. 5 is a flow diagram of a routine for automatically determining model defaults in an embodiment. Although this figure depicts functional steps in a particular order for purposes of illustration, the process is not limited to any particular order or arrangement of steps. One skilled in the art will appreciate that the various steps portrayed in the figure could be omitted or rearranged or adapted in various ways.

In one embodiment, a model can be prepared before being populated with defaults. By way of a non-limiting illustration, numeric values throughout the model can be converted to a common unit, such as the International System of Units (SI). In another non-limiting illustration, all 3D polygons describing surfaces and openings can be transformed into rectangular geometry (i.e., planar, rectangular surface with height and width, tilt, and azimuth orientation). After performing any required transformations, the rectangular geometries can be expressed in Imperial Units (IP). If the model is represented as a gbXML document, rectangular coordinates can be associated with the RectangularGeometry element in the document.

Referring to FIG. 5, Step 500 automatically populates the model with weather defaults. Weather information can be obtained based on the campus node's indication of geographic location (and, optionally, the Year Modeled, if not the current year). In one embodiment, weather information can be obtained from the National Oceanic and Atmospheric Administration National Weather Service. If weather information is not available for a given location, the next closest location with weather information is chosen by default. Weather information is needed in order to simulate a typical meteorological period of time and measure the effect changes in temperature and light have on building energy use. In addition, derivative information such as design day parameters can be provided as defaults in the model. Design day parameters can be used to paint worse case scenarios for heat and cold loads, for example. Using this information, the minimum required size/power of HVAC equipment can be established. Typical weather information is provided in Table 3. If the model is a gbXML document, this information can be associated with the Weather element in the document.

TABLE 3
Weather Defaults in an Embodiment

| WEATHER | |
|---|---|
| INFORMATION | DESCRIPTION |
| Weather_Id | The unique ID for each weather location. |
| Name | Name of weather location. |
| City | Primary city of weather location. |
| State | Primary state of weather location. |
| HDD65 | Heating degree day base 65. |
| HDD60 | Heating degree day base 60. |
| HDD55 | Heating degree day base 55. |
| HDD50 | Heating degree day base 50. |
| CDD80 | Heating degree day base 80. |
| CDD75 | Heating degree day base 75. |
| CDD70 | Heating degree day base 70. |
| CDD65 | Heating degree day base 65. |
| DDDBCool | Cool design day maximum dry-bulb temperature. |
| | Unit: ° C. |
| DDHiHrCool | Cool design day hour maximum dry-bulb |
| | temperature occurs. |
| DDWBCool | Cool design day wet-bulb temperature at max. DB |
| | temperature. Unit: ° C. |
| DDDBRangeCool | Cool design day dry-bulb temperature range. |
| | Unit: ° C. |
| DDLoHrCool | Cool design day hour minimum dry-bulb |
| | temperature occurs. |
| DDPressureCool | Cool design day barometric pressure. |
| | Unit: Pascals |
| DDWindSpeedCool | Cool design day wind speed. Unit: m/s |
| DDWindDirCool | Cool design day wind direction. Unit: degree |
| DDSkyClearnessCool | Cool design day sky clearness. |
| DDRainCool | Cool design day rain indicator. |
| DDSnowCool | Cool design day snow indicator. |
| DDMonthCool | Cool design day month. |
| DDDayCool | Cool design day day of the month. |
| DDDaylightCool | Cool design day daylight savings indicator. |
| DDGroundTCool | Cool design day dry-bulb ground temperature. |
| | Unit: ° C. |
| DDDBHeat | Heat design day maximum dry-bulb temperature. |
| | Unit: ° C. |
| DDHiHrHeat | Heat design day hour maximum dry-bulb |
| | temperature occurs. |
| DDWBHeat | Heat design day wet-bulb temperature at max. DB |
| | temperature. Unit: ° C. |
| DDDBRangeHeat | Heat design day dry-bulb temperature range. |
| | Unit: ° C. |
| DDLoHrHeat | Heat design day hour minimum dry-bulb |
| | temperature occurs. |
| DDPressureHeat | Heat design day barometric pressure. |
| | Unit: Pascals |
| DDWindSpeedHeat | Heat design day wind speed. Unit: m/s |
| DDWindDirHeat | Heat design day wind direction. Unit: degree |
| DDSkyClearnessHeat | Heat design day sky clearness. |
| DDRainHeat | Heat design day rain indicator. |
| DDSnowHeat | Heat design day snow indicator. |
| DDMonthHeat | Heat design day month. |
| DDDayHeat | Heat design day day of the month. |
| DDDaylightHeat | Heat design day daylight savings indicator. |
| DDGroundTHeat | Heat design day dry-bulb ground temperature. |
| | Unit: ° C. |
| GroundTemps | Ground temperatures for weather location |
| | for each month. Twelve values comma seperated. |
| | Unit: ° C. |
| References | References for this data. |

Step 502 automatically populates each building in the model with intelligent defaults. In one embodiment, defaults can be chosen based on the type of building, the size of building, the geographic location of the building, and/or any applicable state and/or building code(s) and/or construction practices for that geographic location that impact energy use. Two exemplary building codes in this regard are ASHREA 90.1: Energy Code for Commercial and High-Rise Residential Buildings by the American Society of Heating, Refrigerating and Air-Conditioning Engineers (ASHRAE), and the State of California's Title 24: Energy Efficiency Standards for Residential and Nonresidential Buildings. Among other things, building codes can provide energy efficiency requirements for a building envelope, equipment, lighting, HVAC, etc.

Once the applicable energy code(s) are determined, a set of building-wide defaults appropriate for building type and conforming to the relevant energy code(s) (if any) can be retrieved from storage (e.g., a database, cache, random access memory, magnetic disk, CD-ROM, etc.) and incorporated into the model. In one embodiment, the building-wide defaults can be retrieved by simply indexing a relational database table using the building type and relevant energy code. Among other things, the building-wide defaults can specify for a building the minimum required efficiency of HVAC equipment, amount of domestic hot water use, schedules of operations for lights, exterior lights, interior equipment (computers, coffee makers, copiers, etc.), exterior equipment (battery chargers for vehicles, etc.), constructions for roof, ceilings, walls (interior and exterior), floors (exterior, interior, slabs, underground slabs, etc.), any envelop construction type including interior walls, floors, underground walls, underground ceilings, underground slabs, doors, glass, windows, skylights, etc. As one might imagine, these building parameters can differ widely from building type to building type (e.g., a restaurant versus and office building). In one embodiment, all schedules take into account holidays and daylight savings.

If the model is a gbXML document, the default building information can be readily integrated. Schedule information can be associated with the Schedule gbXML element. Construction information can be associated in the Construction gbXML element. External equipment can be associated in the ExtEquip gbXML element. Internal equipment can be associated in the IntEquip gbXML element. Finally, lighting information can be associated with the Lighting gbXML element.

Step 504 automatically populates each space in each building in the model with intelligent defaults. If a given building has no space types defined, a default space type based on the building type and/or applicable energy code(s) can be automatically provided. A set of space defaults appropriate for space type and conforming to the relevant energy code(s) (if any) can be retrieved from storage and incorporated into the model. In one embodiment, the space defaults can include lighting, light levels (e.g., how bright or dim the space should be), internal equipment, air flow information including accounting for air leaking due to infiltration, the number of people in the space, the amount of heat and moisture the people will emit, the occupancy schedule (e.g., how many people are in the space at a particular time during the year), the fresh air requirements for the space (e.g., based on the number of people in the space, the type of space, and/or the volume of the space), the lighting schedule, the unoccupied lighting schedule, equipment schedules, the desired temperature, etc. If the model is a gbXML document, the default space information can be readily associated with the Space, Construction, IntEquip, and Schedule gbXML elements in the document.

Step 506 automatically assigns each space in each building to a zone. In one embodiment, a zone is a collection of one or more spaces that are cooled or heated by the same HVAC system potentially under the same control. Generally speaking, spaces within a given zone have similar thermal loads and operation schedules. By way of a non-limiting example, a space serving as a computer room in an office building needs to be maintained at a certain (i.e. cold) temperature around the clock. Other spaces in the building function as offices and will generally be warmer and require no air or heat during the night when there are no people present. In this situation, the computer room will be served by a separate HVAC system than the other spaces, since it would be inefficient to keep all of the spaces at the same temperature as the computer room around the clock.

By way of second non-limiting example, in the northern hemisphere the south side of building receives a significant amount of direct sun light during the day whereas the north side of a building does not. It is likely in this situation that a single HVAC system will attempt to cool spaces located on the north side of the building while attempting to heat spaces located on the south side. Since a single HVAC system cannot simultaneously heat and cool, a second HVAC system must be introduced to serve such that one system serves spaces on the north side and another system serves spaces on the south.

Once spaces have been group into one or more zones, “air side” equipment (e.g., fans, ducts, coils, etc., i.e., systems) is automatically created to serve each zone. Default information for the equipment can include, flow rates, schedule, temperature deltas, relative humidity, power requirements, capacity and efficiency, etc. If the model is a gbXML document, this information can be associated with the AirLoop element in the document.

Step 508 automatically creates one or more HVAC plants to serve the system(s) established in Step 506. Each zone is provided an HVAC plant which has adequate capacity to accommodate the design day scenarios for the spaces in its zone while conforming to the minimum efficiency requirements mandated by the building to which the zone belongs. If required, a domestic hot water system is created as well. If the model is a gbXML document, this information can be associated with the HydronicLoop element in the document.

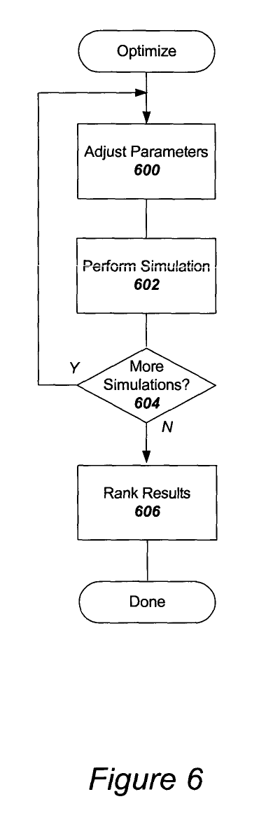

FIG. 6 is a flow diagram of a routine for optimizing a building model. Although this figure depicts functional steps in a particular order for purposes of illustration, the process is not limited to any particular order or arrangement of steps. One skilled in the art will appreciate that the various steps portrayed in the figure could be omitted or rearranged or adapted in various ways. In Step 600, model parameters can be adjusted prior to performing an energy analysis (or “simulation run”) of one or more buildings (Step 602). In one embodiment, any information in the model can be specified as an optimization parameter (e.g., lighting and light control schemes, building materials, the range of thermal resistance (R-Value) of building materials, the mass of walls, the density of floors/ceilings, parameters related to envelop construction, etc.). Each parameter can be held constant or restricted to a range of possible values. The user can specify parameters via a GUI or via configuration information.

In one embodiment, the optimizer can automatically vary construction materials to analyze their effect on the energy efficiency of a building. For example, mass construction (e.g., bricks, concrete, etc.) versus light construction (e.g., steel, wood, etc.) change the thermal characteristics of a building. In one embodiment, the optimizer can automatically rotate the building(s) in the model to determine whether or not a particular orientation will effect the energy efficiency of the building (e.g., rotation could reduce or increase the amount of passive solar exposure). A user can also restrict the degree to which the optimizer can rotate a building by specifying a rotation range. In another embodiment, the optimizer can automatically determine what class of HVAC system (appropriate for a building type) uses the least amount of energy.

In one embodiment, the optimizer can automatically optimize the glass (glazing) used in the building(s). Glass has a variety of properties that can be taken into account during optimization, in one embodiment these include the amount of visible light the glass transmits, whether the glass can reflect infrared radiation, whether the glass is single, double or triple layer; the tint of the glass; the solar heat gain coefficient range; the U-Value (thermal transmission properties) range; the type of frame, etc. In addition, the optimizer can automatically take into account the fact that different types of glass allow artificial lights to be turned off because sufficient natural light enters the space through the glass in an opening. If the model specifies a particular tint of glass (e.g., as chosen by the architect for aesthetic reasons), the optimizer can automatically hold constant the tint of glass while varying other glass properties to determine which is glass is optimal in terms its effect on the overall energy efficiency of a building.

After the model is analyzed with a given set of parameters, step 604 determines whether or not additional simulations need to be performed based on the results of any prior energy analyses and the goal of the optimization. For example, additional simulations may need to be performed to exhaust all combinations of parameters and/or to optimize a given set of building features. If so, parameters are adjusted in step 600 and another simulation is automatically performed. If not, the results of the simulation runs can be ranked (step 606) according to criteria such as energy efficiency, cost savings, project cost, and/or other suitable factors. The ranked results can be presented in a GUI, report and/or stored for future reference.

In one embodiment, the EAM can automatically populate a model and/or generate a report with the results of a simulation. This disclosure is not limited to or dependent on any particular set of results, result granularity, and/or result format. Nor is it limited to or dependent on any particular simulation engine. However, the various simulation engines that the simulation server may employ to analyze a model might produce extremely detailed, even cryptic results. This information may be at too fine a level of granularity to be of any immediate value to a CAD tool user (e.g., an architect). Therefore, in one embodiment simulation results are summarized such that a CAD tool user can quickly ascertain key indicators of a given model's energy efficiency. The summary can be produced by the simulation server and/or the EAM. If the model is a gbXML document, the results of the simulation can be associated with the Results gbXML element and reference the relevant gbXML document elements. Results can apply to buildings and/or spaces within the buildings and can be a function of any period of time. Results can also be persisted in storage.

In one embodiment and by way of a non-limiting illustration, simulation results can be organized into four categories: 1) energy use and costs; 2) thermal loads; 3) equipment sizes and constructions; and 4) comfort measures. These results and their gbXML document mappings are summarized in the following tables.

TABLE 4
Energy Use & Cost Results in an Embodiment

| | CAN BE MAPPED TO |
|---|---|
| RESULT | gbXML ELEMENTS |
| Electricity Peak Demand | Campus, Building |
| Electricity Use | Campus, Building |
| Electricity Cost | Campus, Building |
| Fuel Use | Campus, Building |
| Fuel Cost | Campus, Building |

Energy use can include the rate of energy use (power) for electricity and fuel (see Table 4). Energy cost can be determined based on the cost of energy in the campus's geographic location or region.

TABLE 5
Thermal Load Results in an Embodiment

| | CAN BE MAPPED |
|---|---|
| | TO gbXML |
| RESULT | ELEMENTS |
| Heating Loads Components | Building, Space |
| Cooling Loads Components | Building, Space |
| Peak Heating Load Components | Building, Space |
| Peak Cooling Load Components | Building, Space |
| Air Flow Requirements | Building, Space |
| Comfort Level | Building, Space |
| Temperature | Building, Space |

Thermal loads can be determined for each component in a building that can transmit or produce a load (see Table 5).

TABLE 6
Equipment and Construction Results in an Embodiment

| | MAPPED TO gbXML |
|---|---|
| RESULT | ELEMENTS |
| System Types | Building |
| Cooling Capacity | AirLoop, HydronicLoop |
| Cooling Equipment Size | AirLoop, HydronicLoop |
| Heating Capacity | AirLoop, HydronicLoop |
| Heading Equipment Size | AirLoop, HydronicLoop |
| Fan CFM (Cubic Feet per Minute) | AirLoop |
| Fan Static Pressure | AirLoop |
| Envelope Construction Summary | Building |

Table 6 contains the results of automatically determining the sizes of various types of equipment based on design conditions. Building-wide defaults used for the system (“air loop”) and plant (“hydronic loop”) equipment can also be provided. Construction information can include all opaque and transparent construction material data including properties and quantities.

TABLE 7
Temperature Results in an Embodiment

| | MAPPED TO |
|---|---|
| | gbXML |
| RESULT | ELEMENTS |
| Monthly Maximum Temperature | Space |
| Monthly Minimum Temperature | Space |
| Monthly Ave. Temperature | Space |

In one embodiment, the results can include monthly minimum, maximum and average temperatures in a building's spaces (see Table 7). Future simulation engines will be able to provide humidity information as well to determine comfort values for a space. These can also be incorporated into the results. In another embodiment, the results can include whether or not building(s) comply with applicable energy codes and, if not, what needs to be done in order to bring the building(s) into compliance. By way of a non-limiting example, a list of non-compliant building features can be automatically generated wherein the applicable energy code requirement(s) can be provided for each non-compliant feature.

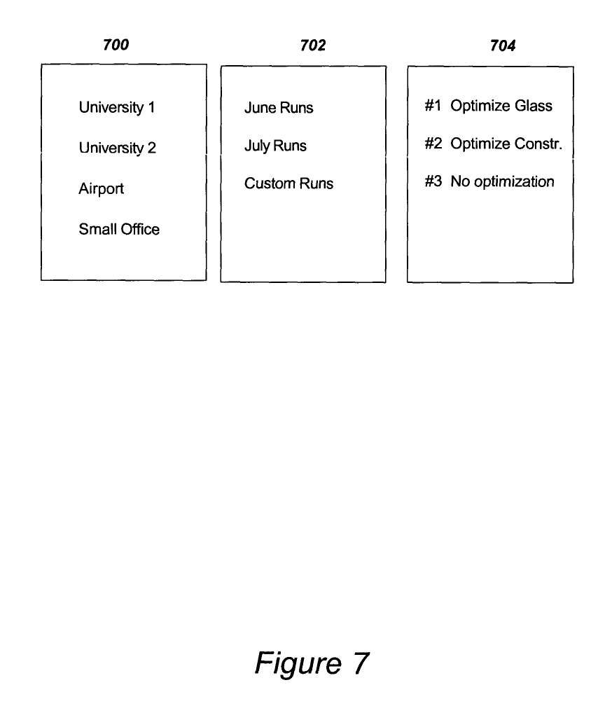

FIG. 7 is an illustration of a graphical user interface in an embodiment. By way of a non-limiting illustration, a user can view the results of an energy analysis of a model by selecting a model from model list 700. Scenarios for the selected model are shown in scenario list 702. For example, if “Airport” was selected, its scenarios would be displayed in the scenario list. A scenario contains at least one energy analysis of the selected model. By way of a non-limiting example, different scenarios might vary the building location (e.g., California, Nevada, New York), construction types, building types, or any other suitable information. The user can select a scenario from the scenario list. Runs for the selected scenario are displayed in run list 704. A run contains the results of an energy analysis of the model. The user can select a run to view its parameters and results. In one embodiment, scenarios, models and runs can be given meaningful names by the user. Any of the lists can be sorted by the information contained therein. By way of a non-limiting example, the runs can be sorted by any combination of date of the run, optimizer rank, energy efficiency, energy cost, or other suitable categories.

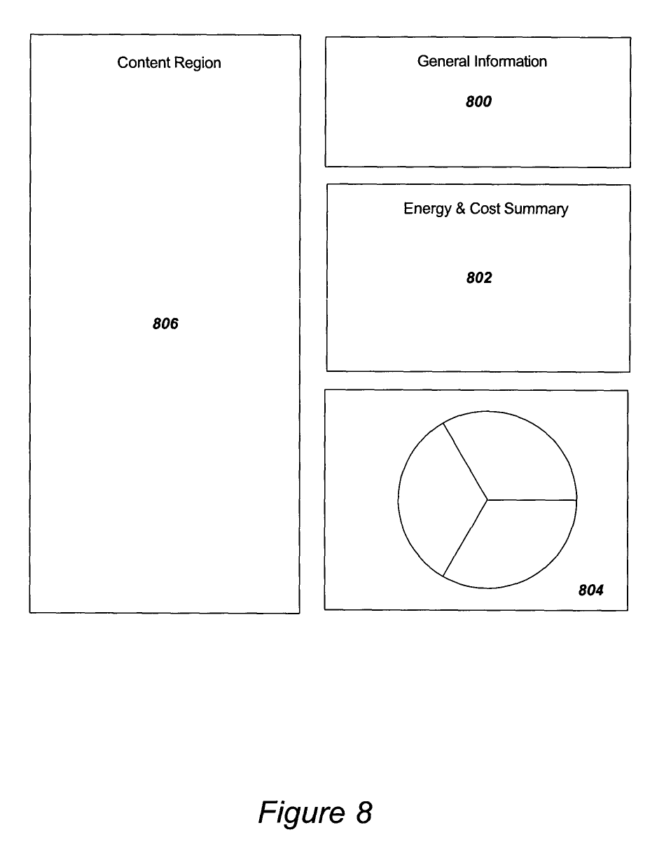

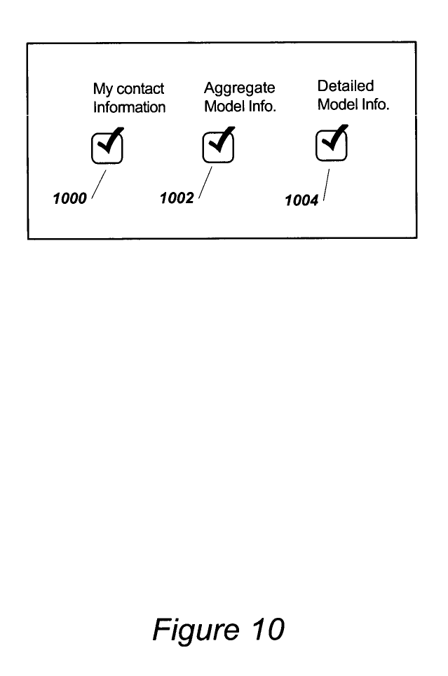

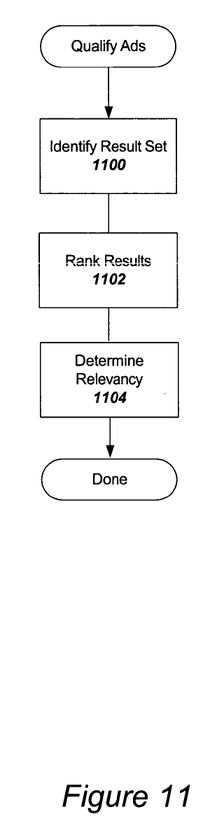

FIG. 8 is an illustration of a graphical user interface for providing the results of a simulation run in an embodiment. In one embodiment, this GUI can be presented as a result of selecting a simulation run in list 704. Region 800 can display general model information, such as building type(s), location, architect and other suitable information. Region 802 can display a summary of the energy analysis including energy use and associated costs for building(s). Region 804 can display a chart or other graphical summary of the information in region 802. There can be at least one content region 806 for displaying advertisement(s) for goods and services and/or other information. The user can select and interact with content displayed in the content region. For example, if the user selects an advertisement, the user can be presented with options to exchange information with vendors (e.g., FIG. 10) or the vendor's website. In one embodiment, advertisements can be chosen for placement in the content region automatically based on information in the model and the energy analysis results (see FIG. 11). This is discussed more fully below.

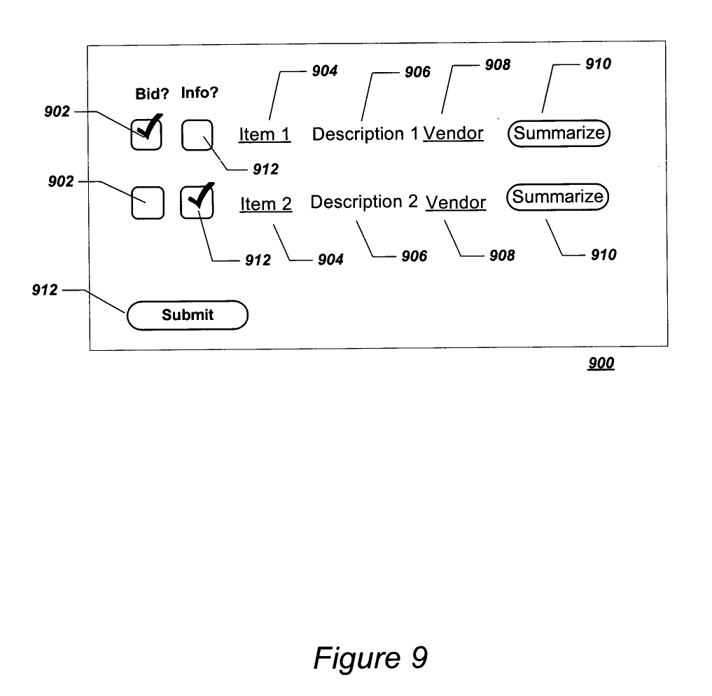

FIG. 9 is an illustration of a graphical user interface for presenting recommendations in an embodiment. In one embodiment, a recommendation component (not shown) can identify opportunities for recommending appropriate third party products and services based on the results of a simulation and/or characteristics of a building. In one embodiment the storage component 106 can include information regarding vendors that supply the equipment for the model defaults. Products/services that would help a user reach energy efficiency goals based on the simulation results can be chosen and presented to the user or in a report.

In one embodiment, each item 904 was chosen by the EAM as being appropriate for the model based on the default information provided in the model by the EAM and/or the outcome of performing an energy simulation on the model. By way of a non-limiting example, typical items might include lighting, glass, HVAC equipment, construction materials, and services. A user may select the item name 904 in order to view more details about the item, such as its technical specifications. The description information 906 contains a brief description of the item. The vendor 908 information contains the name of the vendor and, if selected, can provided detailed information about the vendor such as the vendor's address, telephone number, web page address, etc. The summarize button 910 allows a user to view all of the instances were the item 904 would be used in the building design(s). In one embodiment, this could be a list of all of the spaces/surfaces where the item would be installed. In another embodiment, this information would be illustrated by showing the user a 3D model with highlights indicating where the item would be installed.

The request bid indicator (e.g., check box) 902 can be selected by the user if the user desires the vendor to submit a bid or quote for providing the item 904 in the user's design. Once the user has selected each item they want a bid on, the user can select the submit button 912 to automatically send bid requests to each respective vendor. In one embodiment, vendors can electronically send back bid results (e.g., project cost, time frame, etc.) which can then be automatically incorporated into GUI 900.

In addition to the request bid indicator 902, a request information indicator (e.g., check box) 912 can be selected by the user if the user desires the vendor to provide additional information on the item 904. Once the user has selected each item they want additional information on, the user can select the submit button 912 to automatically send bid and/or information requests to each respective vendor. In one embodiment, vendors can electronically send back the information which can then be automatically incorporated into GUI 900.

FIG. 10 is an illustration of a graphical user interface for presenting information access options in an embodiment. In one embodiment, this GUI can be presented to the user as a result of interaction with the GUIs presented in FIGS. 8 or 9, or through some other interaction or activity of the system. By way of a non-limiting example, this GUI could be invoked as a result of a user selecting an advertisement in content region 806 or requesting a bid or information from a vendor. In these instances, a vendor would need access to a user's model and/or simulation results in order to provide an appropriate response. The user can elect by selecting a check-box 1000 (or via some other GUI device) to provide their contact information to the vendor. The user can also elect to provide their model and results to the vendor in aggregate form 1002 or in complete detail 1004.

FIG. 11 is a flow diagram of a routine for qualifying advertisements in an embodiment. Although this figure depicts functional steps in a particular order for purposes of illustration, the process is not limited to any particular order or arrangement of steps. One skilled in the art will appreciate that the various steps portrayed in the figure could be omitted or rearranged or adapted in various ways.

In one embodiment, advertisements or other information can be selected (or qualified) for presentation to a user based on information contained in building model, its defaults and/or energy analysis results. In one embodiment, a computer database or storage component of at least one information provider can be maintained. An information provider can be a vendor of goods and services, but is not limited to such. In one embodiment, an information provider can be represented by a system (e.g., a database, a server, a web service, etc.) that has to ability to provide content when requested to do so. In one embodiment, content is presented to a user in a GUI (e.g., a web browser). In one embodiment, content can be in the form of advertisements such as for products or services. Or the content can be informational in nature. Content can include (but is not limited to) at least one of: 1) a uniform resource locator (URL); a hypertext markup language (HTML) document; 3) an extensible markup language (XML) document; 4) an audio/visual presentation; 5) text; and 6) an image. In one embodiment, such content can be displayed in content region 806.

In one embodiment, data for each information provider can be maintained in storage component 106. The data can include one or more sets of building criteria, content (or content references), and account information. A content category can also be associated with the content. In one embodiment, the content category can correspond to a product type (e.g., glazing, HVAC, or other model information). If the content is a content reference, the reference provides a location (e.g. a content provider) from which the content can be accessed. In one embodiment, the account information can include but is not limited to information such as an account balance and other suitable information. The building criteria can include at least one of: building area, building type, building location, building space types, cooling and/or heating loads, total building glazing area, heat load on glazing, glazing area by space, amount of glazing by elevation, minimum SHGC (Solar Heat Gain Coefficient) requirement, minimum U-value (i.e., thermal transmission properties) requirement, glazing dimensions, building heating and/or cooling loads, building and/or space CFM (Cubic Feet per Minute) requirements, total building cooling and heating loads, heating and cooling load by space, building and space latent and sensible cooling loads, design day conditions, building operation schedule, building type, space types, potential for daylighting and/or occupancy lighting controls, and any information in the model, defaults and/or energy analysis results.

In Step 1100, a result set is identified. A result set includes information providers in the storage component 106 whose building criteria are at least partially satisfied by the model, defaults and/or energy analysis results. In one embodiment, criteria can be satisfied if it corresponds to (e.g., matches or is similar to) information in the model, defaults and/or energy analysis results. In Step 1102, the result set is ranked to create a result list. In one embodiment, the ranking can be based on at least one of the following: 1) the number of criteria satisfied for a given information provider; 2) an amount of credit, payment, bid or other valuable consideration an information provider is willing to, or has provided in exchange for placement in the result list and/or for a click-through event (e.g., if a user selects or interacts with the content); and 3) content category. A system and method for ranking search results based on a bid amount is disclosed in U.S. Pat. No. 6,269,361 entitled “SYSTEM AND METHOD FOR INFLUENCING A POSITION ON A SEARCH RESULT LIST GENERATED BY A COMPUTER NETWORK SEARCH ENGINE”, issued on Jul. 31, 2001, which is hereby incorporated by reference in its entirety.

In Step 1104, a relevancy score can be determined. This step is optional. In one embodiment, relevancy can be based on the number of criteria that were satisfied by the model and/or energy analysis results. The relevancy score can be presented along with the content. In one embodiment, selected advertisements/content can be presented in content region 806 in order of rank and/or relevancy. In one embodiment, if an information provider's content is presented, the provider's account balance can be updated to reflect a charge for said presentation and/or said user interaction with the presented content.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A method of analyzing the energy requirements of a building using a computer network, comprising:
under control of a first process:
providing a first representation of the building, wherein the first representation of the building is a comprehensive and accurate geometric representation of the building;
providing the first representation to a second process on the computer network;
under control of the second process:
performing an energy analysis of the building based on the first representation; and
providing results of the energy analysis wherein the results are available on the computer network; and
wherein the first process and the second process can communicate using the computer network.

2. The method of claim 1 wherein:
the comprehensive and accurate geometric representation of the building includes a complete and detailed geometry of: the building, spaces in the building, building surfaces and building openings.

3. The method of claim 1 wherein:
the first representation is provided by a 3D-CAD or BIMA application.

4. The method of claim 1, further comprising:
automatically providing default values for the first representation appropriate for performing an energy analysis of the building, wherein the default values can include at least one of: 1) heating, ventilation and/or air conditioning equipment; 2) weather-related information; 3) interior/exterior constructions; 4) interior/exterior lighting equipment; 5) schedules of operations for interior/exterior lights; 6) interior/exterior equipment; 7) schedules of operations for interior/exterior equipment; 8) air flow information; 9) schedules of operations for heating, ventilation and/or air conditioning equipment; 10) number of people; 11) schedules of occupancy for people; and 12) any additional information necessary to conduct a building energy analysis.

5. The method of claim 4 wherein:
the default values can be based on 1) building type; and 2) geographic location of the building.

6. The method of claim 4, further comprising:
incorporating the default values into the first representation of the building.

7. The method of claim 1, wherein:
the first representation of the building can be in one of the following forms: 1) Extensible Markup Language (XML); 2) Green Building XML (gbXML); and 3) International Alliance for Interoperability Industry Foundation Classes.

8. The method of claim 7, wherein:
the first representation of the building is at least one of: 1) compressed; 2) encoded; and 3) encrypted.

9. The method of claim 1 wherein:
the first representation of the building can include at least one of: 1) a building type; 2) a space; 3) a three dimensional representation of the building; 4) a location of the building; 5) at least one surface; and 6) an opening.

10. The method of claim 9 wherein:
the at least one space can include at least one of: 1) space type; and 2) at least one surface.

11. The method of claim 1 wherein:
the results of the energy analysis can include at least one of: 1) energy cost over a period of time; 2) peak demand over a period of time; 3) fuel use over a period of time; 4) electricity use over a period of time; 5) airflow requirements over a period of time; 6) comfort level over a period of time; 7) temperatures over a period of time; 8) cooling equipment sizes; 9) whether or not a building complies with applicable energy codes; 10) what needs to be done in order to bring a building into conformance with applicable energy codes; 11) heating equipment sizes; and 12) any information in the first representation and/or any default values provided for the first representation.

12. The method of claim 1 wherein:
the results of the energy analysis can apply to at least one of: 1) the building; 2) one or more spaces within the building; and 3) any information in the first representation and/or any default values provided for the first representation.

13. The method of claim 1 wherein:
the results of the energy analysis are persisted.

14. The method of claim 1 further comprising:
incorporating the results of the energy analysis into a second representation of the building, wherein the second representation of the building is based on the first representation.

15. The method of claim 4 further comprising:
incorporating the results of the energy analysis into a second representation of the building, wherein the second representation of the building is based on the first representation.

16. The method of claim 1, further comprising:
utilizing the results of the energy analysis to optimize the first representation of the building.

17. The method of claim 16 wherein:
optimization can include optimizing at least one of the following parameters: 1) building orientation; 2) glazing; 3) construction materials; 4) heating air conditioning and/or ventilation systems; 5) lighting and light control schemes; and 6) any information in the first representation.

18. The method of claim 17 wherein:
each of the parameters can be held constant or restricted to a range of possible values.

19. The method of claim 1 wherein:
the energy analysis can be performed in whole or in part by at least one of the following programs: 1) DOE-2; and 2) EnergyPlus.

20. The method of claim 1 wherein:
the computer network can include at least one of the following: 1) the Internet; 2) public networks; and 3) private networks.

21. The method of claim 1 wherein:
the first representation of the building is a 3D mono-planarization representation.

22. The method of claim 1, further comprising:
providing content to a user based on information in at least one of: 1) the first representation; and 2) the results.

23. The method of claim 4, further comprising:
providing content to a user based on information in at least one of: 1) the first representation; 2) the defaults; and 3) the results.

24. The method of claim 22 wherein:
the content can include advertisements.

25. The method of claim 24 wherein:
an advertisement can be selected by a user; and
wherein the selection can cause at least one of the following to be made accessible to a third party: 1) user contact information; 2) information based on the first representation; 3) information based on the energy analysis results; and 4) information based on default values appropriate for performing an energy analysis of the building.

26. The method of claim 24 wherein:
an advertisement can be selected by a user; and
wherein the selection can cause the user to be prompted for permission to make accessible at least one of the following to a third party: 1) user contact information; 2) information based on the first representation; 3) information based on the energy analysis results; and 4) information based on default values appropriate for performing an energy analysis of the building.

27. The method of claim 1, further comprising:
requesting a bid from a third party based on at least one of: 1) the first representation; 2) the energy analysis results; and 3) default values appropriate for performing an energy analysis of the building.

28. The method of claim 1 wherein:
a first user can allow other users to access and/or manipulate at least one of: 1) the first representation; 2) the energy analysis results; and 3) default values appropriate for performing an energy analysis of the building.

29. A method of analyzing the energy requirements of a building using a computer network, comprising:
providing a first representation of the building wherein the first representation is available on the computer network, and wherein the first representation is a comprehensive and accurate geometric representation of the building;
automatically providing default values for the first representation appropriate for performing an energy simulation of the building;
performing an energy analysis of the building based on the first representation and the default values;
providing results of the energy analysis wherein the results are available on the computer network; and
wherein the default values can be based on at least one of: 1) type of the building; 2) geographic location of the building; 3) size of the building; and 4) applicable energy codes.

30. The method of claim 29 wherein:
the comprehensive and accurate geometric representation of the building includes a complete and detailed geometry of: the building, spaces in the building, building surfaces and building openings.

31. The method of claim 29 wherein:
the first representation is provided by a 3D-CAD or BIMA application.

32. The method of claim 29, further comprising:
automatically providing default values for the first representation appropriate for performing an energy analysis of the building, wherein the default values can include at least one of: 1) heating, ventilation and/or air conditioning equipment; 2) weather-related information; 3) interior/exterior constructions; 4) interior/exterior lighting equipment; 5) schedules of operations for interior/exterior lights; 6) interior/exterior equipment; 7) schedules of operations for interior/exterior equipment; 8) air flow information; 9) schedules of operations for heating, ventilation and/or air conditioning equipment; 10) number of people; 11) schedules of occupancy for people; and 12) any additional information necessary to conduct a building energy analysis.

33. The method of claim 32 wherein:
the default values can be based on 1) building type; and 2) geographic location of the building.

34. The method of claim 32, further comprising:
incorporating the default values into the first representation of the building.

35. The method of claim 29 wherein:
the first representation of the building can be in one of the following forms: 1) Extensible Markup Language (XML); 2) Green Building XML (gbXML); and 3) International Alliance for Interoperability Industry Foundation Classes.

36. The method of claim 35 wherein:
the first representation of the building is at least one of: 1) compressed; 2) encoded; and 3) encrypted.

37. The method of claim 29 wherein:
the first representation of the building can include at least one of: 1) a building type; 2) a space; 3) a three dimensional representation of the building; 4) a location of the building; 5) at least one surface; and 6) an opening.

38. The method of claim 37 wherein:
the at least one space can include at least one of: 1) space type; and 2) at least one surface.

39. The method of claim 29 wherein:
the results of the energy analysis can include at least one of: 1) energy cost over a period of time; 2) peak demand over a period of time; 3) fuel use over a period of time; 4) electricity use over a period of time; 5) airflow requirements over a period of time; 6) comfort level over a period of time; 7) temperatures over a period of time; 8) cooling equipment sizes; 9) whether or not a building complies with applicable energy codes; 10) what needs to be done in order to bring a building into conformance with applicable energy codes; 11) heating equipment sizes; and 12) any information in the first representation and/or the default values provided for the first representation.

40. The method of claim 29 wherein:
the results of the energy analysis can apply to at least one of: 1) the building; 2) one or more spaces within the building; and 3) any information in the first representation and/or the default values provided for the first representation.

41. The method of claim 29 wherein:
the results of the energy analysis are persisted.

42. The method of claim 29 further comprising:
incorporating the results of the energy analysis into a second representation of the building, wherein the second representation of the building is based on the first representation.

43. The method of claim 32 further comprising:
incorporating the results of the energy analysis into a second representation of the building, wherein the second representation of the building is based on the first representation.

44. The method of claim 29, further comprising:
utilizing the results of the energy analysis to optimize the first representation of the building.

45. The method of claim 44 wherein:
optimization can include optimizing at least one of the following parameters: 1) building orientation; 2) glazing; 3) construction materials; 4) heating air conditioning and/or ventilation systems; 5) lighting and light control schemes; and 6) any information in the first representation.

46. The method of claim 45 wherein:
each of the parameters can be held constant or restricted to a range of possible values.

47. The method of claim 29 wherein:
the energy analysis can be performed in whole or in part by at least one of the following programs: 1) DOE-2; and 2) EnergyPlus.

48. The method of claim 29 wherein:
the computer network can include at least one of the following: 1) the Internet; 2) public networks; and 3) private networks.

49. The method of claim 29 wherein:
the first representation of the building is a 3D mono-planarization representation.

50. The method of claim 29, further comprising:
providing content to a user based on information in at least one of: 1) the first representation; and 2) the results.

51. The method of claim 32, further comprising:
providing content to a user based on information in at least one of: 1) the first representation; 2) the defaults; and 3) the results.

52. The method of claim 50 wherein:
the content can include advertisements.

53. The method of claim 52 wherein:
an advertisement can be selected by a user; and
wherein the selection can cause at least one of the following to be made accessible to a third party: 1) user contact information; 2) information based on the first representation; 3) information based on the energy analysis results; and 4) information based on default values appropriate for performing an energy analysis of the building.

54. The method of claim 52 wherein:
an advertisement can be selected by a user; and
wherein the selection can cause the user to be prompted for permission to make accessible at least one of the following to a third party: 1) user contact information; 2) information based on the first representation; 3) information based on the energy analysis results; and 4) information based on default values appropriate for performing an energy analysis of the building.

55. The method of claim 29, further comprising:
requesting a bid from a third party based on at least one of: 1) the first representation; 2) the energy analysis results; and 3) default values appropriate for performing an energy analysis of the building.

56. The method of claim 29 wherein:
a first user can allow other users to access and/or manipulate at least one of: 1) the first representation; 2) the energy analysis results; and 3) default values appropriate for performing an energy analysis of the building.

57. A method for performing energy analysis of a building using a computer network, comprising:
receiving from a process on the computer network a first representation of the building or a reference to the first representation of the building;
automatically providing default values for the first representation appropriate for performing an energy simulation of the building;
performing an energy analysis of the building by providing the first representation and the default values to an energy analysis simulator; and
providing results of the energy analysis wherein the results are available on the computer network; and
wherein the first representation of the building is a comprehensive and accurate geometric representation of the building.

58. The method of claim 57 wherein:
the comprehensive and accurate geometric representation of the building includes a complete and detailed geometry of: the building, spaces in the building, building surfaces and building openings.

59. The method of claim 57 wherein:
the first representation is provided by a 3D-CAD or BIMA application.

60. The method of claim 57, further comprising:
automatically providing default values for the first representation appropriate for performing an energy analysis of the building, wherein the default values can include at least one of: 1) heating, ventilation and/or air conditioning equipment; 2) weather-related information; 3) interior/exterior constructions; 4) interior/exterior lighting equipment; 5) schedules of operations for interior/exterior lights; 6) interior/exterior equipment; 7) schedules of operations for interior/exterior equipment; 8) air flow information; 9) schedules of operations for heating, ventilation and/or air conditioning equipment; 10) number of people; 11) schedules of occupancy for people; and 12) any additional information necessary to conduct a building energy analysis.

61. The method of claim 60 wherein:
the default values can be based on 1) building type; and 2) geographic location of the building.

62. The method of claim 60, further comprising:
incorporating the default values into the first representation of the building.

63. The method of claim 57, wherein:
the first representation of the building can be in one of the following forms: 1) Extensible Markup Language (XML); 2) Green Building XML (gbXML); and 3) International Alliance for Interoperability Industry Foundation Classes.

64. The method of claim 63, wherein:
the first representation of the building is at least one of: 1) compressed; 2) encoded; and 3) encrypted.

65. The method of claim 57 wherein:
the first representation of the building can include at least one of: 1) a building type; 2) a space; 3) a three dimensional representation of the building; 4) a location of the building; 5) at least one surface; and 6) an opening.

66. The method of claim 65 wherein:
the at least one space can include at least one of: 1) space type; and 2) at least one surface.

67. The method of claim 57 wherein:
the results of the energy analysis can include at least one of: 1) energy cost over a period of time; 2) peak demand over a period of time; 3) fuel use over a period of time; 4) electricity use over a period of time; 5) airflow requirements over a period of time; 6) comfort level over a period of time; 7) temperatures over a period of time; 8) cooling equipment sizes; 9) whether or not a building complies with applicable energy codes; 10) what needs to be done in order to bring a building into conformance with applicable energy codes; 11) heating equipment sizes and 12) any information in the first representation and/or any default values provided for the first representation.

68. The method of claim 57 wherein:
the results of the energy analysis can apply to at least one of: 1) the building; 2) one or more spaces within the building; and 3) any information in the first representation and/or any default values provided for the first representation.

69. The method of claim 57 wherein:
the results of the energy analysis are persisted.

70. The method of claim 57 further comprising:
incorporating the results of the energy analysis into a second representation of the building, wherein the second representation of the building is based on the first representation.

71. The method of claim 60 further comprising:
incorporating the results of the energy analysis into a second representation of the building, wherein the second representation of the building is based on the first representation.

72. The method of claim 57, further comprising:
utilizing the results of the energy analysis to optimize the first representation of the building.

73. The method of claim 72 wherein:
optimization can include optimizing at least one of the following parameters: 1) building orientation; 2) glazing; 3) construction materials; 4) heating air conditioning and/or ventilation systems; 5) lighting and light control schemes; and 6) any information in the first representation.

74. The method of claim 60 wherein:
each of the parameters can be held constant or restricted to a range of possible values.

75. The method of claim 57 wherein:
the energy analysis can be performed in whole or in part by at least one of the following programs: 1) DOE-2; and 2) EnergyPlus.

76. The method of claim 57 wherein:
the computer network can include at least one of the following: 1) the Internet; 2) public networks; and 3) private networks.

77. The method of claim 57 wherein:
the first representation of the building is a 3D mono-planarization representation.

78. The method of claim 57, further comprising:
providing content to a user based on information in at least one of: 1) the first representation; and 2) the results.

79. The method of claim 60, further comprising:
providing content to a user based on information in at least one of: 1) the first representation; 2) the defaults; and 3) the results.

80. The method of claim 78 wherein:
the content can include advertisements.

81. The method of claim 80 wherein:
an advertisement can be selected by a user; and
wherein the selection can cause at least one of the following to be made accessible to a third party: 1) user contact information; 2) information based on the first representation; 3) information based on the energy analysis results; and 4) information based on default values appropriate for performing an energy analysis of the building.

82. The method of claim 80 wherein:
an advertisement can be selected by a user; and
wherein the selection can cause the user to be prompted for permission to make accessible at least one of the following to a third party: 1) user contact information; 2) information based on the first representation; 3) information based on the energy analysis results; and 4) information based on default values appropriate for performing an energy analysis of the building.

83. The method of claim 57, further comprising:
requesting a bid from a third party based on at least one of: 1) the first representation; 2) the energy analysis results; and 3) default values appropriate for performing an energy analysis of the building.

84. The method of claim 57 wherein:
a first user can allow other users to access and/or manipulate at least one of: 1) the first representation; 2) the energy analysis results; and 3) default values appropriate for performing an energy analysis of the building.

85. A method for optimizing a building represented by a three dimensional (3D) volumetric representation, said method comprising:
automatically performing at least one energy simulation of the representation while varying at least one of the following representation parameters: 1) building orientation; 2) type of glass; 3) heating ventilation air conditioning (HVAC) equipment; and 4) type of constructions;
automatically ranking the results of the at least one energy simulation according to predetermined criteria; and
wherein the 3D volumetric representation of the building is a comprehensive and accurate geometric representation of the building.

86. The method of claim 85 wherein:
the comprehensive and accurate geometric representation of the building includes a complete and detailed geometry of: the building, spaces in the building, building surfaces and building openings.

87. The method of claim 85, further comprising:
automatically optimizing at least one of the following parameters: 1) building orientation; 2) glazing; 3) construction materials; 4) heating air conditioning and/or ventilation systems; 5) lighting and light control schemes; and 6) any information in the representation.

88. The method of claim 85 wherein:
each of the parameters can be held constant or restricted to a range of possible values.

89. The method of claim 85, further comprising:
automatically converting the 3D volumetric representation of the building to a 3D mono-planar representation.

90. The method of claim 85 wherein:
the representation is provided by a 3D-CAD or BIMA application.

91. The method of claim 85, further comprising:
automatically providing default values for the representation appropriate for performing an energy analysis of the building, wherein the default values can include at least one of: 1) heating, ventilation and/or air conditioning equipment; 2) weather-related information; 3) interior/exterior constructions; 4) interior/exterior lighting equipment; 5) schedules of operations for interior/exterior lights; 6) interior/exterior equipment; 7) schedules of operations for interior/exterior equipment; 8) air flow information; 9) schedules of operations for heating, ventilation and/or air conditioning equipment; 10) number of people; 11) schedules of occupancy for people; and 12) any additional information necessary to conduct a building energy analysis.

92. The method of claim 91 wherein:
the default values can be based on 1) building type; and 2) geographic location of the building.

93. The method of claim 91, further comprising:
incorporating the default values into the representation of the building.

94. The method of claim 85, wherein:
the representation of the building can be in one of the following forms: 1) Extensible Markup Language (XML); 2) Green Building XML (gbXML); and 3) International Alliance for Interoperability Industry Foundation Classes.

95. The method of claim 94, wherein:
the representation of the building is at least one of: 1) compressed; 2) encoded; and 3) encrypted.

96 The method of claim 85 wherein:
the representation of the building can include at least one of: 1) a building type; 2) a space; 3) a three dimensional representation of the building; 4) a location of the building; 5) at least one surface; and 6) an opening.

97. The method of claim 96 wherein:
the at least one space can include at least one of: 1) space type; and 2) at least one surface.

98. The method of claim 85 wherein:
the results of the simulation can include at least one of: 1) energy cost over a period of time; 2) peak demand over a period of time; 3) fuel use over a period of time; 4) electricity use over a period of time; 5) airflow requirements over a period of time; 6) comfort level over a period of time; 7) temperatures over a period of time; 8) cooling equipment sizes; 9) whether or not a building complies with applicable energy codes; 10) what needs to be done in order to bring a building into conformance with applicable energy codes; 11) heating equipment sizes; and 12) any information in the representation and/or any default values provided for the first representation.

99. The method of claim 85 wherein:
the results of the simulation can apply to at least one of: 1) the building; 2) one or more spaces within the building; and 3) any information in the representation and/or any default values provided for the first representation.

100. The method of claim 85 wherein:
the results of the simulation are persisted.

101. The method of claim 85 further comprising:
incorporating the results of the simulation into a second representation of the building, wherein the second representation of the building is based on the first representation.

102. The method of claim 91 further comprising:
incorporating the results of the simulation into a second representation of the building, wherein the second representation of the building is based on the first representation.

103. A method for allowing a user to interact with content using a computer network, comprising:
automatically providing the content to the user based on a set of criteria associated with the content, and wherein at least one of the criteria is satisfied based on a representation of a building and/or results of an energy analysis of the representation of the building;
allowing the user to interact with the content; and
wherein the interaction can result in at least one of: 1) a request for information; 2) a request for a bid; 3) permission to access information associated with the user; 4) providing permission to access information associated with the representation of the building and/or results of the energy analysis.

104. The method of claim 103 wherein:
permission to access information can be given for an aggregate view of the information or for the entirety of the information.

105. The method of claim 103 wherein:
the content is provided to the user via the World Wide Web.

106. The method of claim 103, further comprising:
performing an energy analysis of the building representation.

107. The method of claim 103, further comprising:
incorporating default values into the first representation of the building.

108. The method of claim 103 wherein:
the representation of the building can be in one of the following forms: 1) Extensible Markup Language (XML); 2) Green Building XML (gbXML); and 3) International Alliance for Interoperability Industry Foundation Classes.

109. The method of claim 108 wherein:
the representation of the building is at least one of: 1) compressed; 2) encoded; and 3) encrypted.

110. The method of claim 103 wherein:
the representation of the building can include at least one of: 1) a building type; 2) a space; 3) a three dimensional representation of the building; 4) a location of the building; 5) at least one surface; and 6) an opening.

111. The method of claim 103 wherein:
the results of the energy analysis can include at least one of: 1) energy cost over a period of time; 2) peak demand over a period of time; 3) fuel use over a period of time; 4) electricity use over a period of time; 5) airflow requirements over a period of time; 6) comfort level over a period of time; 7) temperatures over a period of time; 8) cooling equipment sizes; 9) whether or not a building complies with applicable energy codes; 10) what needs to be done in order to bring a building into conformance with applicable energy codes; 11) heating equipment sizes; and 12) any information in the representation and/or any default values provided for the first representation.

112. The method of claim 103 wherein:
the results of the energy analysis can apply to at least one of: 1) the building; 2) one or more spaces within the building; and 3) any information in the representation and/or any default values provided for the first representation.

113. The method of claim 103, further comprising:
utilizing the results of the energy analysis to optimize the first representation of the building.

114. The method of claim 103 wherein:
the computer network can include at least one of the following: 1) the Internet; 2) public networks; and 3) private networks.

115. The method of claim 103 wherein:
the content can include advertisements.

116. A method for generating a qualified result list based on a building representation and using a computer network, comprising:
maintaining a database of at least one information provider, wherein each of the at least one information providers has associated with it a set of building criteria and content;
identifying a result set of the at least one information providers that have criteria at least partially satisfied by the building representation and/or an energy analysis of the building representation;
ranking the information providers in the result set into a result list; and
providing content via the computer network corresponding to at least the highest ranked information provider in the result list.

117. The method of claim 116 wherein:
the ranking is based on at least one of the following: 1) the number of criteria satisfied for a given information provider; 2) an amount of credit an information provider will provide in exchange for placement in the result list; and 3) content category.

118. The method of claim 117 wherein:
the content category corresponds to a product type.

119. The method of claim 116 wherein:
content can include at least one of: 1) a uniform resource locator (URL); a hypertext markup language (HTML) document; 3) an extensible markup language (XML) document; 4) an audio/visual presentation; 5) text; and 6) an image.

120. The method of claim 116 wherein:
the content associated with an information provider can include promotional content.

121. The method of claim 116 wherein:
the energy analysis of the building representation has been optimized.

122. The method of claim 116 wherein:
the criteria can include at least one of: building area, building type, building location, building space types, cooling and/or heating loads, total building glazing area, heat load on glazing, glazing area by space, amount of glazing by elevation, minimum SHGC (Solar Heat Gain Coefficient) requirement, minimum U-value requirement, glazing dimensions, building heating and/or cooling loads, building and/or space CFM (Cubic Feet per Minute) requirements, total building cooling and heating loads, heating and cooling load by space, building and space latent and sensible cooling loads, design day conditions, building operation schedule, building type, space types, potential for daylighting and/or occupancy lighting controls, and anything in the building representation and/or energy analysis of the building representation.

123. The method of claim 116, further comprising:
determining a relevancy score for each of the information providers at least one of: 1) the result set; and 2) the result list.

124. The method of claim 116 wherein the step of providing via the computer network the at least highest ranked information provider includes:
presenting the at least highest ranked information provider(s) to a user in order of rank.

125. The method of claim 116 wherein the step of providing via the computer network the at least highest ranked information provider includes:
presenting the at least highest ranked information provider(s) according to information category.

126. A method for providing a plurality of defaults for a building using a computer network, comprising:
providing a representation of the building on the computer network;
automatically providing for the representation at least one of the following defaults: 1) heating, ventilation and/or air conditioning equipment (HVAC); and 2) weather-related information; and
wherein the defaults can be based on at least one of: 1) type of the building; 2) geographic location of the building; 3) size of the building; and 4) applicable energy codes.

127. The method of claim 126, further comprising:
automatically providing for the representation at least one of the following defaults: 1) interior/exterior constructions; 2) interior/exterior lighting equipment; 3) schedules of operations for interior/exterior lights; 4) interior/exterior equipment; 5) schedules of operations for interior/exterior equipment; 6) air flow information; 7) schedules of operations for heating, ventilation and/or air conditioning equipment; 8) number of people; 9) schedules of occupancy for people; and 10) any additional information necessary to conduct a building energy analysis.

128. The method of claim 126, further comprising:
obtaining weather-related information from a weather source over the computer network based on at least one of: 1) a location of the building; and 2) a location geographically nearest to the location of the building wherein there is weather-related information available for the location.

129. The method of claim 126, wherein:
the weather-related information can include design day parameters.

130. The method of claim 126, further comprising:
establishing the minimum required size/power of HVAC equipment.

131. The method of claim 126, further comprising:
integrating into the representation the defaults.

132. The method of claim 126 wherein:
the representation can be in one of the following forms: 1) Extensible Markup Language (XML); 2) Green Building XML; and 3) IFC (Industry Foundation Classes).

133. The method of claim 126 wherein:
the plurality of defaults can include at least one of: 1) minimum required efficiency of HVAC equipment; 2) amount of domestic hot water use; 3) schedules of operations for lights, exterior lights, interior equipment, and/or exterior equipment; and 4) constructions for roof, ceilings, walls, and/or floors; 5) any additional information necessary to conduct a building energy analysis.

134. The method of claim 126 wherein:
the plurality of defaults can include an envelop construction type, wherein the envelope construction type can include at least one of the following: interior walls, floors, underground walls, underground ceilings, underground slabs, doors, glass, windows and skylights.

135. The method of claim 126 wherein:
the representation includes at least one space.

136. The method of claim 135, further comprising:
providing a default space type.

137. The method of claim 133, further comprising:
providing defaults for the at least one space, wherein the defaults can include at least one of: lighting, light levels and internal equipment.

138. The method of claim 133, further comprising:
providing defaults for the at least one space, wherein the defaults can include air flow information including at least one of: information to account for air leaking due to infiltration, a number of people in the space, an amount of heat and moisture that occupants will emit, an occupancy schedule, a fresh air requirements for the space, a lighting schedule, an unoccupied lighting schedule, equipment schedules, and the desired temperature.

139. The method of claim 135, further comprising:
assigning each of the at least one spaces to an HVAC zone.

140. A system comprising:
means for providing a first representation of a building wherein the first representation is available on a computer network, and wherein the first representation is a comprehensive and accurate geometric representation of the building;
means for automatically providing default values for the first representation appropriate for performing an energy simulation of the building;
means for performing an energy analysis of the building based on the first representation and the default values;
means for providing results of the energy analysis wherein the results are available on the computer network; and
wherein the default values can be based on at least one of: 1) type of the building; 2) geographic location of the building; 3) size of the building; and 4) applicable energy codes.

141. A system for analyzing the energy requirements of a building using a computer network, comprising:
a defaults component operable to automatically provide default values for a first representation of the building appropriate for performing an energy simulation of the building, and wherein the first representation is available on the computer network;
an analyzer component coupled to the defaults component and operable to performing an energy analysis of the building based on the first representation and the default values;
wherein the results of the energy analysis can be made available on the computer network;
wherein the default values can be based on at least one of: 1) type of the building; 2) geographic location of the building; 3) size of the building; and 4) applicable energy codes; and
wherein the first representation is a comprehensive and accurate geometric representation of the building;

142. The system of claim 141 wherein:
the comprehensive and accurate geometric representation of the building includes a complete and detailed geometry of: the building, spaces in the building, building surfaces and building openings.

143. The system of claim 141 wherein:
the first representation is provided by a 3D-CAD or BIMA application.

144. The system of claim 141, further comprising:
automatically providing default values for the first representation appropriate for performing an energy analysis of the building, wherein the default values can include at least one of: 1) heating, ventilation and/or air conditioning equipment; 2) weather-related information; 3) interior/exterior constructions; 4) interior/exterior lighting equipment; 5) schedules of operations for interior/exterior lights; 6) interior/exterior equipment; 7) schedules of operations for interior/exterior equipment; 8) air flow information; 9) schedules of operations for heating, ventilation and/or air conditioning equipment; 10) number of people; 11) schedules of occupancy for people; and 12) any additional information necessary to conduct a building energy analysis.

145. The system of claim 144 wherein:
the default values can be based on 1) building type; and 2) geographic location of the building.

146. The system of claim 144, further comprising:
incorporating the default values into the first representation of the building.

147. The system of claim 141 wherein:
the first representation of the building can be in one of the following forms: 1) Extensible Markup Language (XML); 2) Green Building XML (gbXML); and 3) International Alliance for Interoperability Industry Foundation Classes.

148. The system of claim 147 wherein:
the first representation of the building is at least one of: 1) compressed; 2) encoded; and 3) encrypted.

149. The system of claim 141 wherein:
the first representation of the building can include at least one of: 1) a building type; 2) a space; 3) a three dimensional representation of the building; 4) a location of the building; 5) at least one surface; and 6) an opening.

150. The system of claim 149 wherein:
the at least one space can include at least one of: 1) space type; and 2) at least one surface.

151. The system of claim 141 wherein:
the results of the energy analysis can include at least one of: 1) energy cost over a period of time; 2) peak demand over a period of time; 3) fuel use over a period of time; 4) electricity use over a period of time; 5) airflow requirements over a period of time; 6) comfort level over a period of time; 7) temperatures over a period of time; 8) cooling equipment sizes; 9) whether or not a building complies with applicable energy codes; 10) what needs to be done in order to bring a building into conformance with applicable energy codes; 11) heating equipment sizes; and 12) any information in the first representation and/or any default values provided for the first representation.

152. The system of claim 141 wherein:
the results of the energy analysis can apply to at least one of: 1) the building; 2) one or more spaces within the building; and 3) any information in the first representation and/or any default values provided for the first representation.

153. The system of claim 141 wherein:
the results of the energy analysis are persisted.

154. The system of claim 141 further comprising:
incorporating the results of the energy analysis into a second representation of the building, wherein the second representation of the building is based on the first representation.

155. The system of claim 144, further comprising:
incorporating the results of the energy analysis into a second representation of the building, wherein the second representation of the building is based on the first representation.

156. The system of claim 141, further comprising:
utilizing the results of the energy analysis to optimize the first representation of the building.

157. The system of claim 156 wherein:
optimization can include optimizing at least one of the following parameters: 1) building orientation; 2) glazing; 3) construction materials; 4) heating air conditioning and/or ventilation systems; 5) lighting and light control schemes; and 6) any information in the first representation.

158. The system of claim 157 wherein:
each of the parameters can be held constant or restricted to a range of possible values.

159. The system of claim 141 wherein:
the energy analysis can be performed in whole or in part by at least one of the following programs: 1) DOE-2; and 2) EnergyPlus.

160. The system of claim 141 wherein:
the computer network can include at least one of the following: 1) the Internet; 2) public networks; and 3) private networks.

161. The system of claim 141 wherein:
the first representation of the building is a 3D mono-planarization representation.

162. The system of claim 141, further comprising:
providing content to a user based on information in at least one of: 1) the first representation; and 2) the results.

163. The system of claim 144, further comprising:
providing content to a user based on information in at least one of: 1) the first representation; 2) the defaults; and 3) the results.

164. The system of claim 163 wherein:
the content can include advertisements.

165. The system of claim 164 wherein:
an advertisement can be selected by a user; and
wherein the selection can cause at least one of the following to be made accessible to a third party: 1) user contact information; 2) information based on the first representation; 3) information based on the energy analysis results; and 4) information based on default values appropriate for performing an energy analysis of the building.

166. The system of claim 164 wherein:
an advertisement can be selected by a user; and
wherein the selection can cause the user to be prompted for permission to make accessible at least one of the following to a third party: 1) user contact information; 2) information based on the first representation; 3) information based on the energy analysis results; and 4) information based on default values appropriate for performing an energy analysis of the building.

167. The system of claim 141, further comprising:
requesting a bid from a third party based on at least one of: 1) the first representation; 2) the energy analysis results; and 3) default values appropriate for performing an energy analysis of the building.

168. The system of claim 141 wherein:
a first user can allow other users to access and/or manipulate at least one of: 1) the first representation; 2) the energy analysis results; and 3) default values appropriate for performing an energy analysis of the building.

169. A machine readable medium having instructions stored thereon that when executed by a processor cause a system to:
provide a first representation of a building wherein the first representation is available on a computer network, and wherein the first representation is a comprehensive and accurate geometric representation of the building;
provide default values for the first representation appropriate for performing an energy simulation of the building;
perform an energy analysis of the building based on the first representation and the default values;
provide results of the energy analysis wherein the results are available on the computer network; and
wherein the default values can be based on at least one of: 1) type of the building; 2) geographic location of the building; 3) size of the building; and 4) applicable energy codes.

170. The machine readable medium of claim 169 wherein:
the comprehensive and accurate geometric representation of the building includes a complete and detailed geometry of: the building, spaces in the building, building surfaces and building openings.

171. The machine readable medium of claim 169 wherein:
the first representation is provided by a 3D-CAD or BIMA application.

172. The machine readable medium of claim 169, further comprising instructions that when executed cause the system to:
provide default values for the first representation appropriate for performing an energy analysis of the building, wherein the default values can include at least one of: 1) heating, ventilation and/or air conditioning equipment; 2) weather-related information; 3) interior/exterior constructions; 4) interior/exterior lighting equipment; 5) schedules of operations for interior/exterior lights; 6) interior/exterior equipment; 7) schedules of operations for interior/exterior equipment; 8) air flow information; 9) schedules of operations for heating, ventilation and/or air conditioning equipment; 10) number of people; 11) schedules of occupancy for people; and 12) any additional information necessary to conduct a building energy analysis.

173. The machine readable medium of claim 172 wherein:
the default values can be based on 1) building type; and 2) geographic location of the building.

174. The machine readable medium of claim 172, further comprising instructions that when executed cause the system to:
incorporate the default values into the first representation of the building.

175. The machine readable medium of claim 169 wherein:
the first representation of the building can be in one of the following forms: 1) Extensible Markup Language (XML); 2) Green Building XML (gbXML); and 3) International Alliance for Interoperability Industry Foundation Classes.

176. The machine readable medium of claim 175 wherein:
the first representation of the building is at least one of: 1) compressed; 2) encoded; and 3) encrypted.

177. The machine readable medium of claim 169 wherein:
the first representation of the building can include at least one of: 1) a building type; 2) a space; 3) a three dimensional representation of the building; 4) a location of the building; 5) at least one surface; and 6) an opening.

178. The machine readable medium of claim 177 wherein:
the at least one space can include at least one of: 1) space type; and 2) at least one surface.

179. The machine readable medium of claim 169 wherein:
the results of the energy analysis can include at least one of: 1) energy cost over a period of time; 2) peak demand over a period of time; 3) fuel use over a period of time; 4) electricity use over a period of time; 5) airflow requirements over a period of time; 6) comfort level over a period of time; 7) temperatures over a period of time; 8) cooling equipment sizes; 9) whether or not a building complies with applicable energy codes; 10) what needs to be done in order to bring a building into conformance with applicable energy codes; 11) heating equipment sizes; and 12) any information in the first representation and/or any default values provided for the first representation.

180. The machine readable medium of claim 169 wherein:
the results of the energy analysis can apply to at least one of: 1) the building; 2) one or more spaces within the building; and 3) any information in the first representation and/or any default values provided for the first representation.

181. The machine readable medium of claim 169 wherein:
the results of the energy analysis are persisted.

182. The machine readable medium of claim 169, further comprising instructions that when executed cause the system to:
incorporate the results of the energy analysis into a second representation of the building, wherein the second representation of the building is based on the first representation.

183. The machine readable medium of claim 169 further comprising instructions that when executed cause the system to:
incorporate the results of the energy analysis into a second representation of the building, wherein the second representation of the building is based on the first representation.

184. The machine readable medium of claim 169, further comprising instructions that when executed cause the system to:
utilize the results of the energy analysis to optimize the first representation of the building.

185. The machine readable medium of claim 184 wherein:
optimization can include optimizing at least one of the following parameters: 1) building orientation; 2) glazing; 3) construction materials; 4) heating air conditioning and/or ventilation systems; 5) lighting and light control schemes; and 6) any information in the first representation.

186. The machine readable medium of claim 185 wherein:
each of the parameters can be held constant or restricted to a range of possible values.

187. The machine readable medium of claim 169 wherein:
the energy analysis can be performed in whole or in part by at least one of the following programs: 1) DOE-2; and 2) EnergyPlus.

188. The machine readable medium of claim 169 wherein:
the computer network can include at least one of the following: 1) the Internet; 2) public networks; and 3) private networks.

189. The machine readable medium of claim 169 wherein:
the first representation of the building is a 3D mono-planarization representation.

190. The machine readable medium of claim 169, further comprising instructions that when executed cause the system to:
provide content to a user based on information in at least one of: 1) the first representation; and 2) the results.

191. The machine readable medium of claim 169, further comprising instructions that when executed cause the system to:
providing content to a user based on information in at least one of: 1) the first representation; 2) the defaults; and 3) the results.

192. The machine readable medium of claim 191 wherein:
the content can include advertisements.

193. The machine readable medium of claim 192 wherein:
an advertisement can be selected by a user; and
wherein the selection can cause at least one of the following to be made accessible to a third party: 1) user contact information; 2) information based on the first representation: 3) information based on the energy analysis results; and 4) information based on default values appropriate for performing an energy analysis of the building.

194. The machine readable medium of claim 192 wherein:
an advertisement can be selected by a user; and
wherein the selection can cause the user to be prompted for permission to make accessible at least one of the following to a third party: 1) user contact information; 2) information based on the first representation; 3) information based on the energy analysis results; and 4) information based on default values appropriate for performing an energy analysis of the building.

195. The machine readable medium of claim 169, further comprising instructions that when executed cause the system to:
request a bid from a third party based on at least one of: 1) the first representation; 2) the energy analysis results; and 3) default values appropriate for performing an energy analysis of the building.

196. The machine readable medium of claim 169 wherein:
a first user can allow other users to access and/or manipulate at least one of: 1) the first representation; 2) the energy analysis results; and 3) default values appropriate for performing an energy analysis of the building.
